(19) United States
(12) Patent Application Publication
(10) Pub. No.: US 2026/0045804 A1
(43) Pub. Date: Feb. 12, 2026

(54) BALANCING BATTERY MODULES FOR AN ENERGY-STORAGE SYSTEM

(71) Applicant: SCHNEIDER ELECTRIC IT CORPORATION, Foxboro, MA (US)

(72) Inventors: Qinggang Kong, Shanghai (CN); Chao Sun, Shanghai (CN); Tongfei Zhang, Shanghai (CN)

(21) Appl. No.: 19/277,679

(22) Filed: Jul. 23, 2025

(30) Foreign Application Priority Data
Aug. 6, 2024 (CN) 202411070075.7

(51) Int. Cl. H02J 7/00

(52) U.S. Cl. CPC H02J 7/0014; H02J 7/0047; H02J 2207/20

(57) ABSTRACT

Examples of the present disclosure include an energy-storage system having a plurality of energy units, each energy unit including a battery module and a power converter coupled to a respective battery module; and at least one controller configured to (a) receive one or more parameter values from each battery module, each parameter value indicating a respective battery module state, (b) determine a difference between a largest parameter value from a first battery module and a smallest parameter value from a second battery module, (c) determine whether the difference is greater than a threshold difference, and (d) control at least one power converter to transfer energy between the first battery module and the second battery module through a lowest number of power converters in response to determining that the difference is greater than the threshold difference.

### CROSS-REFERENCE TO RELATED APPLICATION

This application claims the benefit under 35 U.S.C. § 119 of Chinese Patent Application No. 202411070075.7, filed Aug. 6, 2024, and titled BALANCING BATTERY MODULES FOR AN ENERGY-STORAGE SYSTEM, which is hereby incorporated herein by reference in its entirety for all purposes.

### BACKGROUND

### 1. Field of the Disclosure

At least one example in accordance with the present disclosure relates generally to energy-storage systems.

### 2. Discussion of Related Art

An energy-storage system (ESS) relates to a device or group of devices capable of storing energy which can be supplied at a later time. Some large-capacity ESSs may include multiple batteries or battery modules. ESSs may be used as energy-storage units and/or backup power sources in various applications such as uninterruptible power supplies (UPSs), renewable energies, peak-shaving, load-leveling, and power-capacity supplementation. When combined with a UPS, an ESS can provide protection from power interruptions and is often used in hospitals, data centers, homes, and so forth.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B—that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

According to at least one aspect of the present disclosure, in one example, an energy-storage system includes a plurality of energy units, each energy unit including a battery module and a power converter coupled to a respective battery module; and at least one controller configured to (a) receive one or more parameter values from each battery module, each parameter value indicating a respective battery module state, (b) determine a difference between a largest parameter value from a first battery module and a smallest parameter value from a second battery module, (c) determine whether the difference is greater than a threshold difference, and (d) control at least one power converter to transfer energy between the first battery module and the second battery module through a lowest number of power converters in response to determining that the difference is greater than the threshold difference.

In another example of the ESS, the at least one controller is further configured to (e) determine one or more power paths between the first battery module and the second battery module, each power path including one or more power converters; (f) determine a number of power converters in each power path; (g) identify a most efficient power path between the first battery module and the second battery module, wherein the most efficient power path includes the lowest number of power converters; and (h) control at least one power converter to transfer energy between the first battery module and the second battery module through the most efficient power path.

In one example of the ESS, the battery module state includes at least one of a state of charge (SOC) or a state of health (SOH) of a respective battery module.

In another example of the ESS, the power converters of the plurality of energy units are coupled in series.

In at least one example of the ESS, each energy unit includes a battery module, a first power converter, and a second power converter, each first power converter and each second power converter being coupled to a respective battery module and to each other. In another example of the ESS, each first power converter and each second power converter are both DC/DC converters or are both AC/DC converters. In another example of the ESS, the plurality of energy units includes a first energy unit having the first battery module; and a second energy unit having the second battery module, wherein transferring energy between the first battery module and the second battery module includes transferring energy through a second respective power converter of the first energy unit and a first respective power converter of the second energy unit.

In one example of the ESS, the at least one controller is further configured to (i) determine a second difference between a parameter value from a third battery module and the smallest parameter value from the second battery module, (j) determine whether the second difference is greater than the threshold difference, and (k) control at least one power converter to transfer energy between the third battery module and the second battery module through a second lowest number of power converters in response to determining that the second difference is greater than the threshold difference.

In some examples of the ESS, the at least one controller is further configured to (l) determine a second difference between the largest parameter value from the first battery module and a parameter value from a third battery module, (m) determine whether the second difference is greater than the threshold difference, and (n) control at least one power converter to transfer energy between the first battery module and the third battery module through a second lowest number of power converters in response to determining that the second difference is greater than the threshold difference.

In another example of the ESS, each energy unit further includes a secondary controller, each secondary controller being communicatively coupled to the at least one controller, the respective power converter, and the respective battery module; receiving the one or more parameter values from each battery module includes receiving the one or more parameter values from a respective secondary controller; and controlling the at least one power converter includes providing control signals to at least one respective secondary controller.

According to another aspect of the present disclosure, a method of controlling an ESS including a plurality of energy units, each energy unit including a respective battery module and a respective power converter coupled to the respective battery module is disclosed.

In one example, the method includes (a) receiving one or more parameter values from each battery module, each parameter value indicating a respective battery module state; (b) determining a difference between a largest parameter value from a first battery module and a smallest parameter value from a second battery module; (c) determining that the difference is greater than a threshold difference; and (d) controlling at least one power converter to transfer energy between the first battery module and the second battery module through a lowest number of power converters in response to determining that the difference is greater than the threshold difference.

In another example of the method, controlling the at least one power converter to transfer energy between the first battery module and the second battery module through the lowest number of power converters includes (e) determining one or more power paths between the first battery module and the second battery module, each power path including one or more power converters; (f) determining a number of power converters in each power path; (g) identifying a most efficient power path between the first battery module and the second battery module, wherein the most efficient power path including the lowest number of power converters; and (h) controlling at least one power converter to transfer energy between the first battery module and the second battery module through the most efficient power path.

In one example, the method further includes (i) determining a second difference between a parameter value from a third battery module and the smallest parameter value from the second battery module; (j) determining that the second difference is greater than the threshold difference; and (k) controlling at least one power converter to transfer energy between the third battery module and the second battery module through a second lowest number of power converters in response to determining that the second difference is greater than the threshold difference.

In another example, the method further includes (l) determining a second difference between the largest parameter value from the first battery module and a parameter value from a third battery module, (m) determining that the second difference is greater than the threshold difference, and (n) controlling at least one power converter to transfer energy between the first battery module and the third battery module through a second lowest number of power converters in response to determining that the second difference is greater than the threshold difference.

In some examples of the method, each energy unit includes a respective battery module, a first respective power converter, and a second respective power converter, the first respective power converter and the second respective power converter being coupled to the respective battery module and to each other; and transferring energy between the first respective battery module and the second respective battery module includes transferring energy through a second respective power converter coupled to the first battery module and a first respective power converter coupled to the second battery module.

According to another aspect of the present disclosure, at least one non-transitory computer-readable medium storing thereon sequences of computer-executable instructions for controlling an energy-storage system including a plurality of energy units, each energy unit including a respective battery module and a respective power converter coupled to the respective battery module is disclosed.

In one example of the at least one non-transitory computer-readable medium, the sequences of computer-executable instructions include instructions that instruct at least one processor to (a) receive one or more parameter values from each battery module, each parameter value indicating a respective battery module state; (b) determine a difference between a largest parameter value from a first battery module of a first energy unit and a smallest parameter value from a second battery module of a second energy unit; (c) determine whether the difference is greater than a threshold difference; and (d) control at least one power converter to transfer energy between the first battery module and the second battery module through a lowest number of power converters in response to determining that the difference is greater than the threshold difference.

In another example of the at least one non-transitory computer-readable medium, controlling the at least one power converter to transfer energy between the first battery module and the second battery module through the lowest number of power converters includes (e) identifying a most efficient power path between the first battery module and the second battery module, the most efficient power path including the lowest number of power converters; and (f) controlling the at least one power converter to transfer energy between the first battery module and the second battery module through the most efficient power path.

In some examples of the at least one non-transitory computer-readable medium, each energy unit includes a respective battery module, a first respective power converter, and a second respective power converter, the first respective power converter and the second respective power converter being coupled to the respective battery module and to each other; and transferring energy between the first battery module of the first energy unit and the second battery module of the second energy unit includes transferring energy through the second respective power converter of the first energy unit and the first respective power converter of the second energy unit.

In one example of the at least one non-transitory computer-readable medium, the instructions further instruct the at least one processor to (g) determine a second difference between a parameter value from a third battery module and the smallest parameter value from the second battery module; (h) determine whether the second difference is greater than the threshold difference; and (i) control at least one power converter to transfer energy between the third battery module and the second battery module through a second lowest number of power converters in response to determining that the second difference is greater than the threshold difference.

In some examples of the at least one non-transitory computer-readable medium, the instructions further instruct the at least one processor to (j) determine a second difference between the largest parameter value from the first battery module and a parameter value from a third battery module; (k) determine whether the second difference is greater than the threshold difference; and (l) control at least one power converter to transfer energy between the first battery module and the third battery module through a second lowest number of power converters in response to determining that the second difference is greater than the threshold difference.

### BRIEF DESCRIPTION OF THE DRAWINGS

Various aspects of at least one embodiment are discussed below with reference to the accompanying figures, which may not be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or substantially similar component that is illustrated in various figures may be represented by a like numeral. For purposes of clarity, not every component may be labeled in every figure. In the figures:

FIG. 1 illustrates a block diagram of an energy-storage system (ESS) coupled to an uninterruptible power supply (UPS) according to an example;

FIG. 2 illustrates a block diagram of an ESS having multiple energy units according to an example;

FIGS. 3A and 3B illustrate example ESSs having multiple energy units while each energy unit includes a battery module and a DC/DC power converter;

FIGS. 4A and 4B illustrate example ESSs having multiple energy units while each energy unit includes a battery module and two power converters;

FIG. 5 illustrates a flow chart for operating an ESS according to an example;

FIG. 6 illustrates a one-to-one balancing process between two battery modules in the ESS topology of FIG. 3A according to an example;

FIG. 7 illustrates a one-to-one balancing process between two battery modules in the ESS topology of FIG. 3A according to another example;

FIG. 8 illustrates a one-to-one balancing process for two separate pairs of battery modules in the ESS topology of FIG. 3A according to another example;

FIG. 9 illustrates a one-to-one balancing process between two battery modules in the ESS topology of FIG. 3B according to an example;

FIG. 10 illustrates a one-to-one balancing process between two battery modules in the ESS topology of FIG. 3B according to another example;

FIG. 11 illustrates a one-to-one balancing process for two separate pairs of battery modules in the ESS of FIG. 3B according to another example;

FIG. 12 illustrates a one-to-one balancing process between two battery modules in the ESS topology of FIG. 4B according to an example;

FIG. 13 illustrates a one-to-one balancing process between two battery modules in the ESS topology of FIG. 4B according to another example;

FIG. 14 illustrates a one-to-one balancing process for two separate pairs of battery modules in the ESS topology of FIG. 4B according to another example;

FIG. 15 illustrates a one-to-multiple balancing process between battery modules in the ESS topology of FIG. 3A according to an example;

FIG. 16 illustrates a one-to-multiple balancing process between battery modules in the ESS topology of FIG. 3B according to an example;

FIG. 17 illustrates a one-to-multiple balancing process between battery modules in the ESS topology of FIG. 4B according to an example;

FIG. 18 illustrates a multiple-to-one balancing process between battery modules in the ESS topology of FIG. 3A according to an example;

FIG. 19 illustrates a multiple-to-one balancing process between battery modules in the ESS topology of FIG. 3B according to an example;

FIG. 20 illustrates a multiple-to-one balancing process between battery modules in the ESS topology of FIG. 4B according to an example;

FIG. 21 illustrates a multiple-to-multiple balancing process between battery modules in the ESS topology of FIG. 3A according to an example;

FIG. 22 illustrates a multiple-to-multiple balancing process between battery modules in the ESS topology of FIG. 3A according to another example;

FIG. 23 illustrates a multiple-to-multiple balancing process between battery modules in the ESS topology of FIG. 3B according to an example;

FIG. 24 illustrates a multiple-to-multiple balancing process between battery modules in the ESS topology of FIG. 3B according to another example;

FIG. 25 illustrates a multiple-to-multiple balancing process between battery modules in the ESS topology of FIG. 4B according to an example; and

FIG. 26 illustrates a multiple-to-multiple balancing process between battery modules in the ESS topology of FIG. 4B according to another example.

### DETAILED DESCRIPTION

Uninterruptible power supplies (UPSs) may be used to provide regulated, uninterrupted power to one or more loads. UPSs may be coupled to a primary power source, such as a utility mains supply, and a secondary power source, such as an energy-storage system (ESS). When primary power is available from the primary power source, the UPS may power the one or more loads using output power derived from the primary power source. When primary power is not available from the primary power source, the UPS may power the one or more loads using output power derived from the secondary power source.

ESSs may be modular. A user may add or remove battery modules from the ESS to increase or decrease the energy capacity of the ESS. In some examples, a large-capacity ESS may have multiple battery modules connected in series. Each battery module includes multiple battery cells, such as electrochemical cells (for example, lithium-ion cells) or other cell types such as mechanical or biological battery cells.

Some of the battery modules in an ESS may have a different state-of-charge (SOC) than the other battery modules in the ESS. For example, a user may operate an ESS with an original group of battery modules for an extended period of time before adding an additional battery module to the ESS. The newly added battery module may have a different SOC than the original group of battery modules. Furthermore, the newly added battery module may have different (for example, higher) state-of-health (SOH) than the original group of battery modules, which have been in operation for an extended period of time. At least because of these differing SOHs, the SOC profile of the newly added battery module may vary differently over time than the SOC profiles of the original group of battery modules. These differences may result in variations in SOCs over time.

Differences in SOC between battery modules in an ESS may result in inefficient utilization of the individual battery modules and/or the ESS as a whole. It may therefore be advantageous to balance the SOCs of the battery modules in an ESS. In various examples of the disclosure, each energy unit in a group of energy units coupled in series includes a respective battery module. Power may be exchanged between individual battery modules to balance the battery modules' SOCs. In various examples, power may be shared from a battery module with a higher SOC to a battery module with a lower SOC. Power may be shared on a one-to-one basis (that is, from one battery module to another battery module), a one-to-multiple basis (that is, from one battery module to multiple battery modules), a multiple-to-one basis (that is, from multiple battery modules to one battery module), and/or a multiple-to-multiple basis (that is, from multiple battery modules to multiple battery modules).

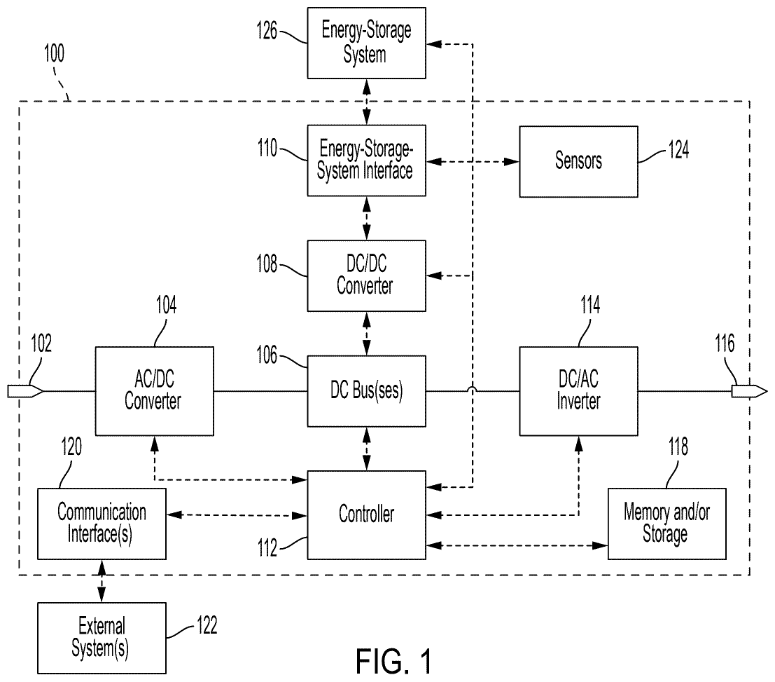

FIG. 1 illustrates a block diagram of a UPS 100 coupled to an ESS 126 to provide power according to an example. The UPS 100 may include an input 102, an AC/DC converter 104, one or more DC busses 106, a DC/DC converter 108, an ESS interface 110, at least one controller 112 (“controller 112”), a DC/AC inverter 114, an output 116, a memory and/or storage 118, one or more communication interfaces 120 (“communication interfaces 120”), which may be communicatively coupled to one or more external systems 122 (“external systems 122”), and one or more voltage sensors and/or current sensors 124 (“sensors 124”).

The input 102 is coupled to the AC/DC converter 104 and to an AC power source (not illustrated), such as an AC mains power supply. The AC/DC converter 104 is coupled to the input 102 and to the one or more DC busses 106, and is communicatively coupled to the controller 112. The one or more DC busses 106 are coupled to the AC/DC converter 104, the DC/DC converter 108, and to the DC/AC inverter 114, and are communicatively coupled to the controller 112. The DC/DC converter 108 is coupled to the one or more DC busses 106 and to the energy-storage-device interface 110, and is communicatively coupled to the controller 112. The energy-storage-device interface 110 is coupled to the DC/DC converter 108, and is configured to be coupled to at least one energy-storage device 126 and/or another energy-storage device. In some examples, the energy-storage-device interface 110 is configured to be communicatively coupled to the controller 112.

In some examples, the UPS 100 may be external to the at least one energy-storage device 126 and may be coupled to the at least one energy-storage device 126 via the energy-storage-device interface 110. In various examples, the UPS 100 may include one or more energy-storage devices, which may include the at least one energy-storage device 126. The at least one energy-storage device 126 may include one or more batteries, capacitors, flywheels, or other energy-storage devices in various examples.

The DC/AC inverter 114 is coupled to the one or more DC busses 106 and to the output 116, and is communicatively coupled to the controller 112. The output 116 is coupled to the DC/AC inverter 114, and to an external load (not pictured). The controller 112 is communicatively coupled to the AC/DC converter 104, the one or more DC busses 106, the DC/DC converter 108, the energy-storage-device interface 110, the DC/AC inverter 114, the memory and/or storage 118, the communication interfaces 120, and/or the at least one energy-storage device 126. The sensors 124 are communicatively coupled to the controller 112 and may be coupled to one or more other components of the UPS 100, such as the input 102, the AC/DC converter 104, the one or more DC busses 106, the DC/DC converter 108, the energy-storage-device interface 110, the DC/AC inverter 114, and/or the output 116.

The input 102 is configured to be coupled to an AC mains power source and to receive input AC power having an input voltage level. The UPS 100 is configured to operate in different modes of operation based on the input voltage of the AC power provided to the input 102. The controller 112 may determine a mode of operation in which to operate the UPS 100 based on whether the input voltage of the AC power is acceptable. The controller 112 may include or be coupled to one or more sensors, such as the sensors 124, configured to sense parameters of the input voltage. For example, the sensors 124 may include one or more voltage and/or current sensors coupled to the input 102 and being configured to sense information indicative of a voltage at the input 102 and provide the sensed information to the controller 112.

When AC power provided to the input 102 is acceptable (for example, by having parameters, such as an input voltage value, that meet specified values, such as by falling within a range of acceptable input voltage values), the controller 112 controls components of the UPS 100 to operate in a normal mode of operation. In the normal mode of operation, AC power received at the input 102 is provided to the AC/DC converter 104. The AC/DC converter 104 converts the AC power into DC power and provides the DC power to the one or more DC busses 106. The one or more DC busses 106 distribute the DC power to the DC/DC converter 108 and to the DC/AC inverter 114. The DC/DC converter 108 converts the received DC power and provides the converted DC power to the energy-storage-device interface 110. The energy-storage-device interface 110 receives the converted DC power, and provides the converted DC power to the at least one energy-storage device 126 to charge the at least one energy-storage device 126. The DC/AC inverter 114 receives DC power from the one or more DC busses 106, converts the DC power into regulated AC power, and provides the regulated AC power to the output 116 to be delivered to a load.

When AC power provided to the input 102 from the AC mains power source is not acceptable (for example, by having parameters, such as an input voltage value, that do not meet specified values, such as by falling outside of a range of acceptable input voltage values), the controller 112 controls components of the UPS 100 to operate in a backup mode of operation. In the backup mode of operation, DC power is discharged from the at least one energy-storage device 126 to the energy-storage-device interface 110, and the energy-storage-device interface 110 provides the discharged DC power to the DC/DC converter 108. The DC/DC converter 108 converts the received DC power and distributes the DC power amongst the one or more DC busses 106. For example, the DC/DC converter 108 may evenly distribute the power amongst the one or more DC busses 106. The one or more DC busses 106 provide the received power to the DC/AC inverter 114. The DC/AC inverter 114 receives the DC power from the one or more DC busses 106, converts the DC power into regulated AC power, and provides the regulated AC power to the output 116.

In some examples, the sensors 124 may include one or more sensors coupled to one or more of the foregoing components such that a voltage and/or current of one or more of the foregoing components may be determined by the controller 112. The controller 112 may store information in, and/or retrieve information from, the memory and/or storage 118. For example, the controller 112 may store information indicative of sensed parameters (for example, input-voltage values of the AC power received at the input 102) in the memory and/or storage 118. The controller 112 may further receive information from, or provide information to, the communication interfaces 120. The communication interfaces 120 may include one or more communication interfaces including, for example, user interfaces (such as display screens, touch-sensitive screens, keyboards, mice, track pads, dials, buttons, switches, sliders, light-emitting components such as light-emitting diodes, sound-emitting components such as speakers, buzzers, and so forth configured to output sound inside and/or outside of a frequency range audible to humans, and so forth), wired communication interfaces (such as wired ports), wireless communication interfaces (such as antennas), and so forth, configured to exchange information with one or more systems, such as the external systems 122, or other entities, such as human beings. The external systems 122 may include any device, component, module, and so forth, that is external to the UPS 100, such as a server, database, laptop computer, desktop computer, tablet computer, smartphone, central controller or data-aggregation system, other UPSs, and so forth.

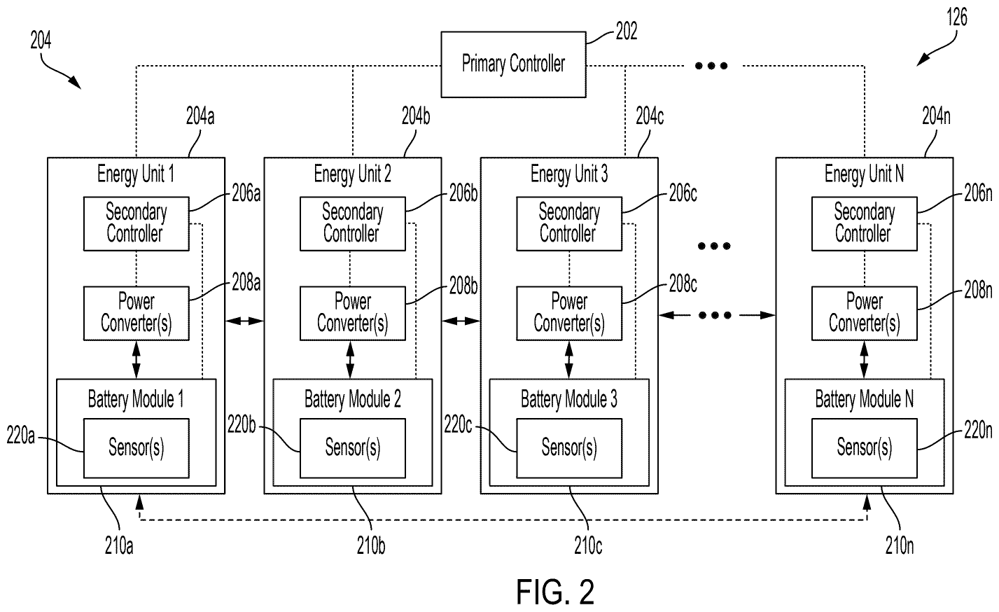

FIG. 2 illustrates a block diagram of the ESS 126 according to an example. In this example, the ESS 126 includes at least one primary controller 202 (“primary controller 202”) and an arbitrary number (N) of energy units 204 including a first energy unit 204a, a second energy unit 204b, a third energy unit 204c, and an Nth energy unit 204n. Although four energy units 204a-204n are illustrated for purposes of example, the ESS 126 may include any number of energy units.

The primary controller 202 is communicatively coupled to each of the energy units 204. The energy units 204a-204n are coupled in series. Each energy unit 204 may be directly coupled to an immediately adjacent energy unit. For example, the first energy unit 204a is directly coupled to the second energy unit 204b, the second energy unit 204b is directly coupled to the first energy unit 204a and the third energy unit 204c, and so forth. In some examples, energy units at the beginning and end of the series connection of the energy units 204 (that is, the first energy unit 204a and the Nth energy unit 204n), which may be referred to as terminal energy units, may or may not be directly coupled to each other. Furthermore, in various examples, each of the energy units 204 may be coupled to each non-adjacent energy unit via one or more intermediary energy units. For example, the first energy unit 204a may be coupled to the third energy unit 204c via the second energy unit 204b.

Each energy unit 204 may include at least one secondary controller 206 (“secondary controller 206”) (depicted as secondary controller 206a, secondary controller 206b, secondary controller 206c, and secondary controller 206n), one or more power converters 208 (“power converter 208”) (depicted as power converter[s] 208a, power converter[s] 208b, power converter[s] 208c, and power converter[s] 208n), and a battery module 210 (depicted as battery module 210a, battery module 210b, battery module 210c, and battery module 210n).

In each of the energy units 204, the power converter 208 is coupled to the battery module 210. The power converter 208 may also be coupled to adjacent energy units. For example, a first power converter 208a of the first energy unit 204a may be coupled to the second energy unit 204b. Each respective secondary controller 206 may be communicatively coupled to the primary controller 202, a respective power converter 208, and a respective battery module 210. For example, a first secondary controller 206a may be communicatively coupled to the primary controller 202, the first power converter 208a, and the first battery module 210a. In some examples, each of the secondary controllers 206 may be coupled to one or more other secondary controllers of the secondary controllers 206.

Each battery module 210 may include one or more battery cells connected in series (not illustrated in FIG. 2). Each battery module 210 may also include one or more sensors 220 that detect one or more parameters of the respective battery module 210 to determine an SOC or SOH of the respective battery module 210. For example, the sensor(s) 220 may include voltage sensors, current sensors, a combination thereof, and so forth. Each power converter 208 may be coupled to the respective battery module 210 in the same energy unit. Under the control of a respective secondary controller 206, each power converter 208 may regulate current flow into (that is, charging) or out of (that is, discharging) a respective battery module 210.

As discussed above, it may be advantageous to transmit power between the energy units 204 to balance the SOCs of the energy units 204. In some examples, each secondary controller 206 may determine an SOC of a respective battery module 210 using information received from a respective sensor 220 and may send the SOC information to the primary controller 202. The primary controller 202 may determine whether and how to balance the SOCs of the energy units 204. For example, the primary controller 202 may determine whether a difference between the highest SOC and the lowest SOC exceeds a threshold value and, if so, control the energy unit with the highest SOC to transfer energy to the energy unit with the lowest SOC. In some examples, the primary controller 202 controlling the energy units 204 may include the primary controller 202 sending signals to respective secondary controllers 206 instructing the secondary controllers 206 to control respective power converters 208. In other examples, the primary controller 202 controls the balancing processes directly without the secondary controllers 206.

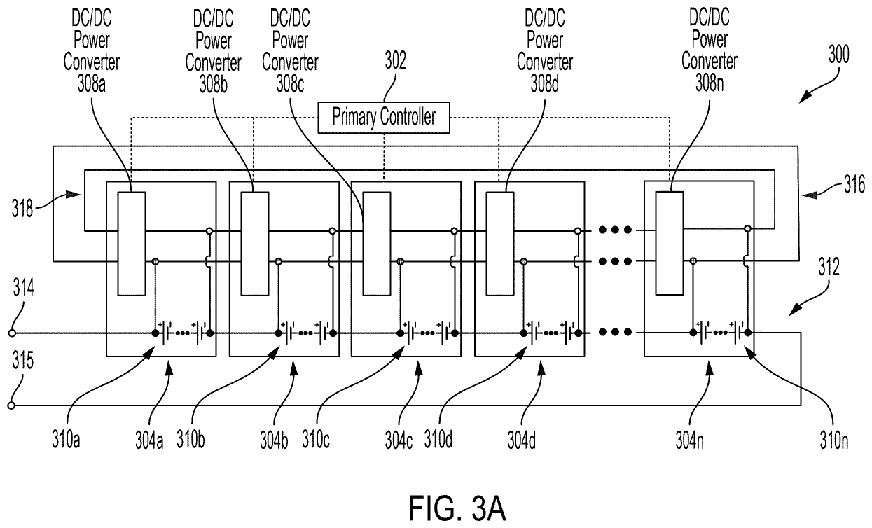

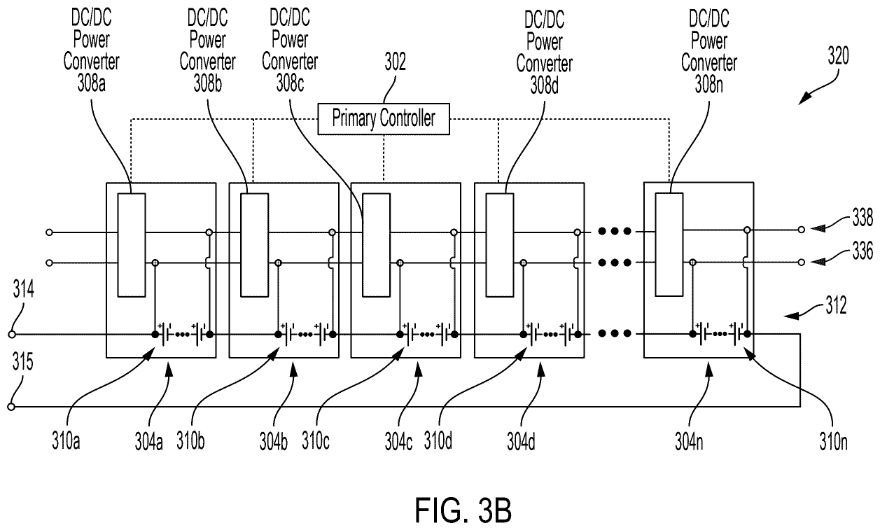

FIG. 3A illustrates a block diagram of an ESS 300 according to an example. The ESS 300 includes a primary controller 302 and an arbitrary number (N) of energy units 304 (depicted as energy unit 304a, energy unit 304b, energy unit 304c, energy unit 304d, and energy unit 304n). Each energy unit 304 includes a respective DC/DC power converter 308 (depicted as DC/DC power converter 308a, DC/DC power converter 308b, DC/DC power converter 308c, DC/DC power converter 308d, and DC/DC power converter 308n) and a respective battery module 310 (depicted as battery module 310a, battery module 310b, battery module 310c, battery module 310d, and battery module 310n). Each battery module 310 includes a set of battery cells connected in series. In some examples, each of the energy units 304 includes a secondary controller as discussed above with respect to FIG. 2. For illustrative clarity, however, the energy units 304 are depicted without explicitly illustrating respective secondary controllers.

The primary controller 302 is communicatively coupled to each energy unit 304. In some examples, the primary controller 302 is coupled to a secondary controller (for example, a secondary controller 206 in FIG. 2) of each energy unit 304. In various examples, including examples in which the energy units 304 do or do not include secondary controllers, the primary controller 302 is coupled to each respective DC/DC power converter 308. Each DC/DC power converter 308 is coupled to the positive connection of a respective battery module 310 via a first power connection 316 and to the negative connection of the respective battery module 310 via a second power connection 318. Each DC/DC power converter 308 is directly coupled to an immediately adjacent DC/DC power converter(s) 308 via the power connections 316, 318. The battery modules 310 are connected in series via a power line 312.

In the example of FIG. 3A, the terminal DC/DC power converters 308a, 308n are also directly coupled to each other. The DC/DC power converters 308a-308n are bidirectional and are coupled in series. The battery modules 310 are connected in series through the power line 312 that extends from a positive battery connection 314 to a negative battery connection 315 through the series connection of the battery modules 310 without passing through any of the DC/DC power converters 308. In at least one example, the positive and negative connections 314, 315 are coupled to the ESS interface 110 of the UPS 100.

FIG. 3B illustrates a block diagram of an ESS 320 according to another example. The ESS 320 is similar to the ESS 300 and like components are labeled accordingly. However, the ESS 320 differs from ESS 300 in that the energy units 304 are coupled in series via a positive power connection 336 and a negative power connection 338. Whereas in FIG. 3A the terminal DC/DC power converters 308a, 308n are coupled directly together via the power connections 316, 318, in FIG. 3B the terminal DC/DC power converters 308a, 308n are not directly coupled to each other via the power connections 336, 338. For example, the first DC/DC power converter 308a is only directly coupled to an immediately adjacent power converter (that is, the second DC/DC power converter 308b) and is not directly coupled to the Nth DC/DC power converter 308n.

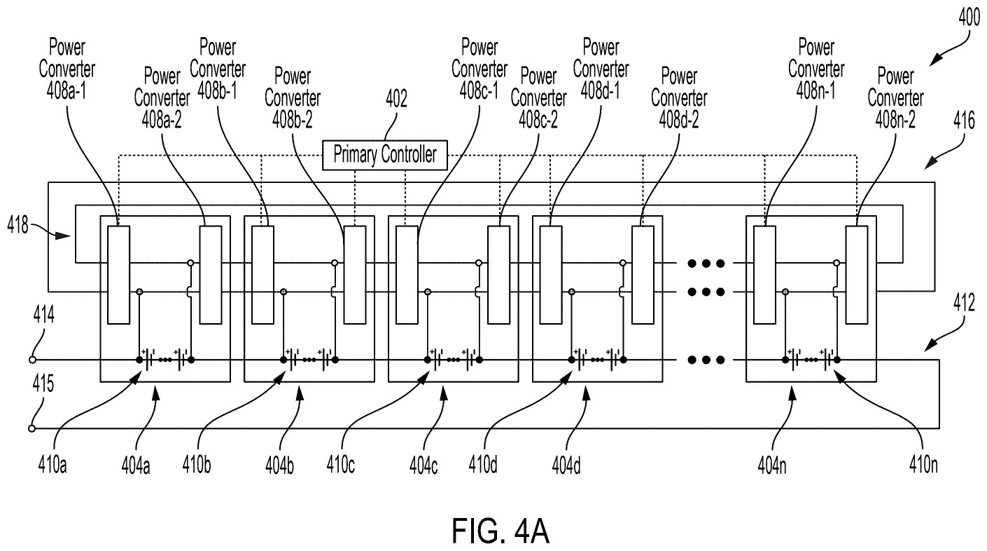

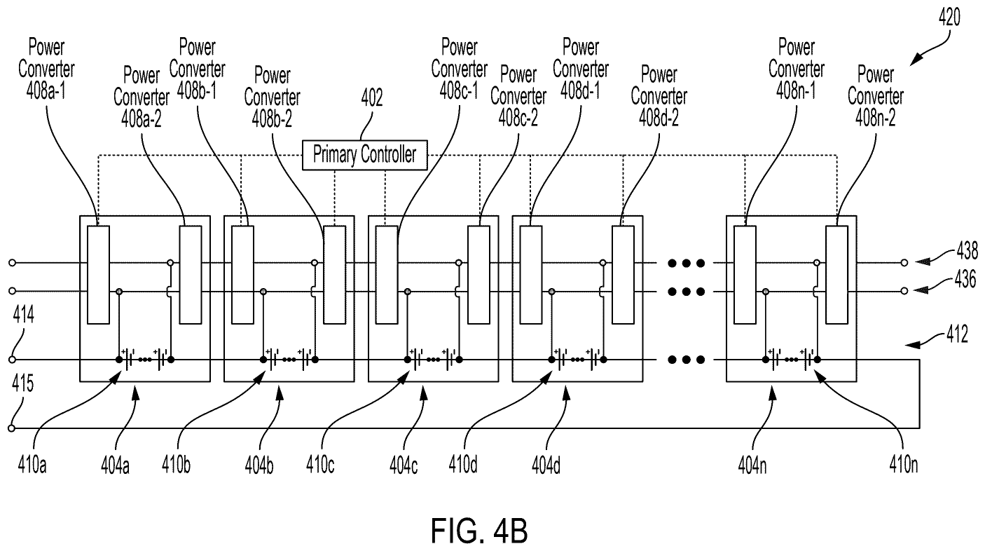

FIG. 4A illustrates a block diagram of an ESS 400 according to an example. The ESS 400 is similar to the ESS 300 and includes multiple energy units. However, whereas each energy unit of the ESS 300 includes a single power converter, each energy unit of the ESS 400 includes multiple power converters. Having two power converters, for example, instead of a single power converter in each energy unit may improve electrical insulation between battery modules and power cables interconnecting different energy units in an ESS.

In more detail, the ESS 400 includes at least one primary controller 402 (“primary controller 402”) and an arbitrary number (N) of energy units 404 (depicted as energy unit 404a, energy unit 404b, energy unit 404c, energy unit 404d, and energy unit 404n). Each energy unit 404 includes a first respective power converter 408-1 (depicted as power converter 408a-1, power converter 408b-1, power converter 408c-1, power converter 408d-1, and power converter 408n-1), a second respective power converter 408-2 (depicted as power converter 408a-2, power converter 408b-2, power converter 408c-2, power converter 408d-2, and power converter 408n-2), and a respective battery module 410 (depicted as battery module 410a, battery module 410b, battery module 410c, battery module 410d, and battery module 410n).

In some examples, each of the energy units 404a-404n includes a respective secondary controller, which is omitted for illustrative clarity. In some examples, the first power converters 408-1 and the second power converters 408-2 are bi-directional DC/DC power converters. In other examples, the first power converters 408-1 and the second power converters 408-2 are bi-directional AC/DC power converters such that power between energy units 404 is AC power, and power within each respective energy unit 404 is DC power. Each battery module 410 includes a set of battery cells connected in series.

The primary controller 402 is communicatively coupled to each power converter 408. In some examples, a respective secondary controller (for example, a secondary controller 206 in FIG. 2) may be communicatively coupled to each power converter 408 and to the primary controller 402. Each of the power converters 408-1, 408-2 in each energy unit 404 is coupled to a positive connection of a respective battery module 410 via a first power connection 416 and to a negative connection of the respective battery module 410 via a second power connection 418. Each pair of the power converters 408-1, 408-2 are also coupled to each other via the power connections 416, 418. The battery modules 410 are connected in series via a power line 412. Each power converter 408 is directly coupled to an immediately adjacent power converter. For example, the second power converter 408a-2 is directly coupled to power converters 408a-1, 408b-1, and is indirectly coupled to power converters 408b-2, 408c-1, 408c-2, 408d-1, 408d-2, 408n-1, and 408n-2. In this example, the terminal power converters 408a-1, 408n-2 are also directly coupled to each other. The power converters 408 are coupled in series. The battery modules 410 are connected in series via a power line 412 and between a positive connection 414 and a negative connection 415.

FIG. 4B illustrates a block diagram of an ESS 420 according to another example. The ESS 420 is similar to the ESS 400, and like components are labeled accordingly. However, whereas in the ESS 400 the first energy unit 404a is coupled directly to the Nth energy unit 404n via the power connections 416, 418, in the ESS 420 the first energy unit 404a is not directly coupled to the Nth energy unit 404n via the power connections 436, 438. However, the first energy unit 404a may still be indirectly coupled to the Nth energy unit 404n via intermediate energy units including energy units 404b-404d.

Accordingly, FIGS. 3A-4B illustrate various examples of the ESS 126 illustrated in FIG. 2. In each example, power may be transferred between energy units 204. The primary controller 202 may determine whether to transfer energy between energy units 204. In at least one example, the primary controller 202 may identify an SOC of each of the energy units 204. The primary controller 202 may determine a difference between the SOC of the energy unit with the highest SOC and the SOC of each of the other energy units. The primary controller 202 may determine which of the SOC differences exceed a threshold value. For each difference above the threshold value, the primary controller 202 may control the energy units 204 to transfer power to the lower-SOC energy unit corresponding to the SOC difference. In this manner, the primary controller 202 identifies and reduces large differences in SOC between the energy units 204.

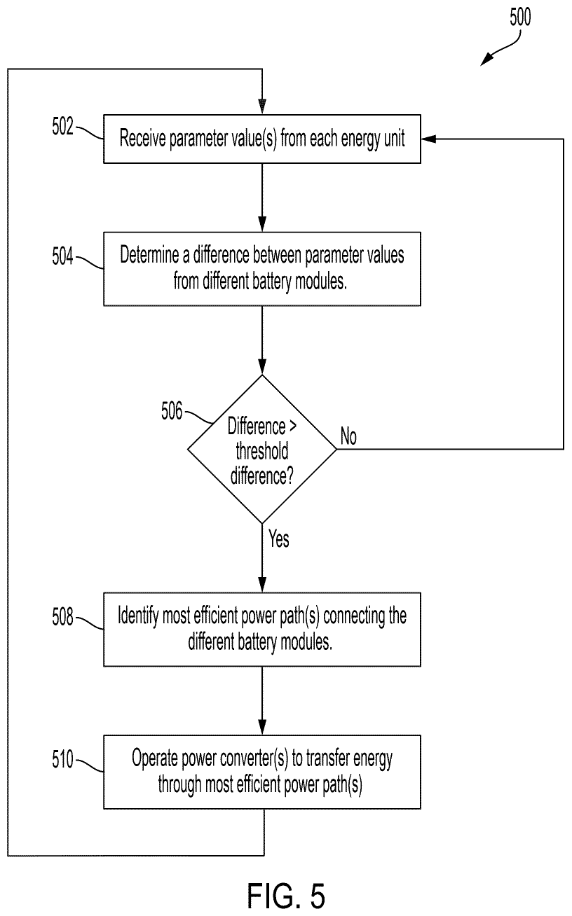

FIG. 5 illustrates a process 500 for operating the ESS 126 according to an example. In this example, the process 500 is described with respect to the ESS 126 of FIG. 2. In various examples, the process 500 may be executed by the primary controller 202 either individually or in combination with one or more of the secondary controllers 206. For ease of explanation, the following discussion refers to examples in which the secondary controllers 206 execute certain operations. However, in other examples, the primary controller 202 may execute one or more (and possibly all) of the operations described as being executed by the secondary controllers 206.

Referring to both FIGS. 2 and 5, at act 502, the primary controller 202 receives one or more parameter values from each energy unit 204. For example, the primary controller 202 may receive the one or more parameter values from the secondary controllers 206. In some examples, a parameter may include an SOC and each parameter value may include an SOC value for a respective battery module 210. For example, act 502 may include the primary controller 202 receiving a first SOC value from the first secondary controller 206a indicating an SOC of the first battery module 210a, receiving a second SOC value from the second secondary controller 206b indicating an SOC of the second battery module 210b, and so forth. In some examples, each of the secondary controllers 206 may determine the SOC value based on information received from the sensors 220, such as a voltage, a current, a temperature, and/or other parameters.

At act 504, the primary controller 202 determines a difference between each pair of parameter values. For example, the primary controller 202 may compare the SOC of the first battery module 210a with the SOC of all of the other battery modules 210b-210n, and may compare the SOC of the second battery module 210b with the SOC of all of the other battery modules 210a, 210c-210n, and so forth. Act 504 may thus include employing various algorithms to compare all parameter values received from all energy units 204. Act 504 may also include employing algorithms to compare all differences between each pair of received parameter values to find the largest difference. For example, act 504 may include arranging the parameter values (for example, the SOC values) in an order from a smallest parameter value to a largest parameter value.

In some examples, the primary controller 202 may compare the largest parameter value (for example, the largest SOC value) with the smallest parameter value (for example, the smallest SOC value). In examples in which the parameter includes an SOC, the largest parameter value may correspond to a battery module having a state of the most remaining charge and the smallest parameter value may indicate a battery module having a state of the least remaining charge. In another example, the largest parameter value may indicate a battery module having a highest voltage value across the battery cells and the smallest parameter value may indicate a battery module having a lowest voltage value across the battery cells.

At act 506, the primary controller 202 determines whether any, and which, of the differences obtained at act 504 are greater than a threshold difference. In various examples, the threshold difference may be expressed as either a fixed value or a relative value. For example, implementing a fixed value may include determining whether a difference in SOC between the SOCs exceeds a fixed value, such as 20% (or any other value equal to or less than 100%) of the standard full capacity of a battery module. Thus, if the highest SOC is 80%, then the threshold difference will be exceeded if the lowest SOC is less than 60%. In another example, implementing a relative value may include determining whether a difference in SOC between the SOCs exceeds a relative value, such as by being within 10% (or any other value) of the value of the highest or lowest SOC. Thus, if the highest SOC is 80%, then the threshold will be exceeded if the lowest SOC is less than 72%; or in another example, if the lowest SOC is 50%, then the threshold will be exceeded if the highest SOC is above 55%.

If the primary controller 202 determines that none of the differences are greater than the threshold difference (506 NO), then the process 500 returns to act 502. As discussed above, act 504 may include ordering the SOC values from a smallest value to a largest value. In some examples, act 506 may first include determining a difference between the smallest and largest values to determine a largest difference and, if the largest difference does not exceed the threshold difference, then the primary controller 202 may not need to determine any other differences to determine that none of the differences exceed the threshold difference (506 NO). Acts 502-506 are repeated (for example, continuously, periodically, or non-periodically) until the primary controller 202 determines that one or more of the differences exceed the threshold difference.

Accordingly, in some examples, the primary controller 202 may execute the evaluation at act 506 to identify at least two of the energy units 204 to transfer power between. For purposes of explanation, an energy unit having a battery module that is receiving power may be referred to as a “charging energy unit,” and an energy unit having a battery module that is providing power to the charging energy unit may be referred to as a “discharging energy unit.”

The primary controller 202 may identify charging energy units as any of the lower-charged energy units 204 that satisfy the threshold evaluation at act 506. The primary controller 202 may identify discharging energy units as any of the higher-charged energy units 204 that satisfy the threshold evaluation at act 506. Accordingly, the primary controller 202 may identify one or more discharging units and may identify one or more charging units based on the evaluation at act 506.

For example, consider an example in which the energy units 204 include a first energy unit with an SOC of 50%, a second energy unit with an SOC of 80%, and a third energy unit with an SOC of 85%. If act 506 is satisfied based on a fixed-value threshold difference of 10% SOC, then the primary controller 202 may determine that the threshold difference is satisfied by the difference between the first-energy-unit SOC and the second-energy-unit SOC (that is, a difference of 30% between 50% and 80%) and is satisfied by the difference between the second-energy-unit SOC and the third-energy-unit SOC (that is, a difference of 35% between 50% and 85%), but is not satisfied by the difference between the second-energy-unit SOC and the third-energy-unit SOC (that is, a difference of 5% between 80% and 85%). In this example, the first energy unit may be considered a charging energy unit and the second and third energy units may be considered discharging energy units. In some examples, an energy unit may be considered both a charging energy unit and a discharging energy unit.

If the primary controller 202 determines that one or more of the differences exceed the threshold difference (506 YES), then the process 500 continues to act 508.

At act 508, the primary controller 202 identifies the most efficient power path(s) between the charging and discharging energy units. The most efficient power path(s) may include the power path(s) that passes from one or more discharging energy units to one or more charging energy units through the lowest number of power converters 208. Minimizing the number of power converters 208 that power passes through may minimize power losses.

For example, suppose that the primary controller 202 determines that power should be provided from the first energy unit 204a to the second energy unit 204b. The primary controller 202 can control the energy units 204 to provide power from the first energy unit 204a to the second energy unit 204b via either of at least two paths. A first path is from the first energy unit 204a to the second energy unit 204b without passing through any other energy units in between. A second path is from the first energy unit 204a to the Nth energy unit 204n, the third energy unit 204c, and finally to the second energy unit 204b. The first path may experience less power loss than the second path, and thus be more efficient, because the power passes through fewer power converters 208.

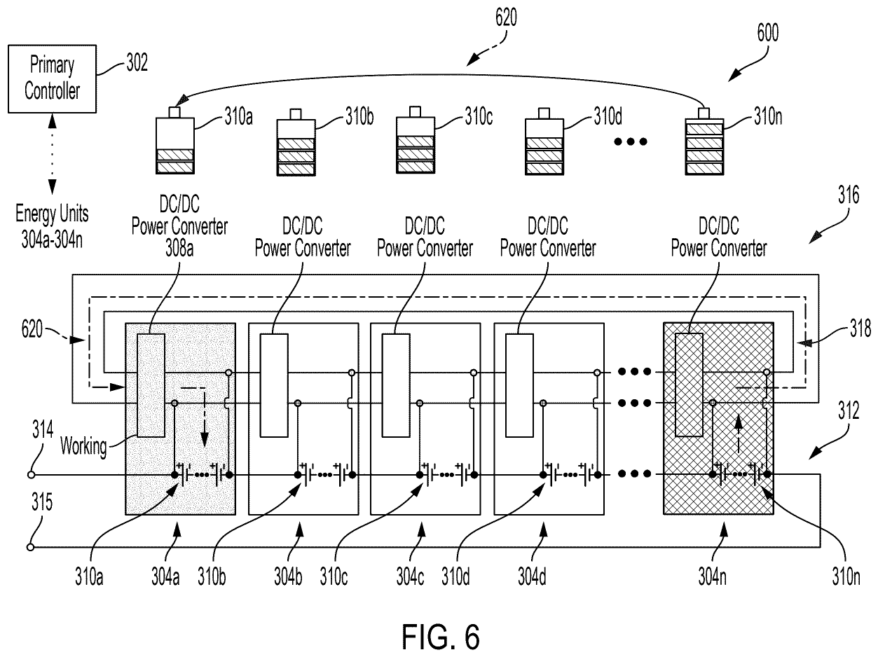

Act 508 may include employing various algorithms to evaluate the efficiencies (for example, the included number of power converters 208) of different balancing power paths connecting those battery modules and selecting the power path(s) with the lowest number of power converters 208 to be the most efficient power path(s). As discussed in greater detail below, act 508 may include identifying not only a most efficient power path between a pair of battery modules, but also identifying multiple most efficient power paths between several different pairs of battery modules. For example, the most efficient power paths may be identified on a one-to-one basis, a one-to-multiple basis, a multiple-to-one basis, a multiple-to-multiple basis, a combination thereof, and so forth. Various examples of the most efficient power path(s) in different ESS topologies and different battery module state scenarios will be described below with respect to FIGS. 6-26.

At act 510, the primary controller 202 sends control signals to operate the power converters in the identified most efficient power path(s) to allow power flow through the corresponding power converter(s) for balancing (that is, transferring energy between) the respective battery modules. The primary controller 202 may instruct the secondary controllers 206 in the energy units 204 that fall within the power path to operate the respective power converters 208 to transfer power to a target battery module 210. For example, suppose that the primary controller 202 determines that the first energy unit 204a is to provide power to the second energy unit 204b. At act 510, the primary controller 202 may instruct the first secondary controller 206a to operate the first power converter 208a, and may instruct the second secondary controller 206b to operate the second power converter 208b, to transfer power from the first battery module 210a to the second battery module 210b. The process 500 may then return to act 502.

As discussed above, in some examples, the primary controller 202 may execute process 500 and perform a balancing operation (that is, transferring power between energy units) on a one-to-one basis. In a one-to-one configuration, the primary controller 202 identifies a single charging energy unit for each discharging energy unit and a single discharging energy unit for each charging energy unit. Thus, in a one-to-one configuration, the primary controller 202 may identify one or more pairs of charging and discharging energy units. These configurations may be considered a one-to-one configuration even if there are (or are not) one or more other energy units disposed in a power path between the discharging energy unit(s) and the charging energy unit(s). Examples of the one-to-one configuration are provided below with respect to FIGS. 6-14.

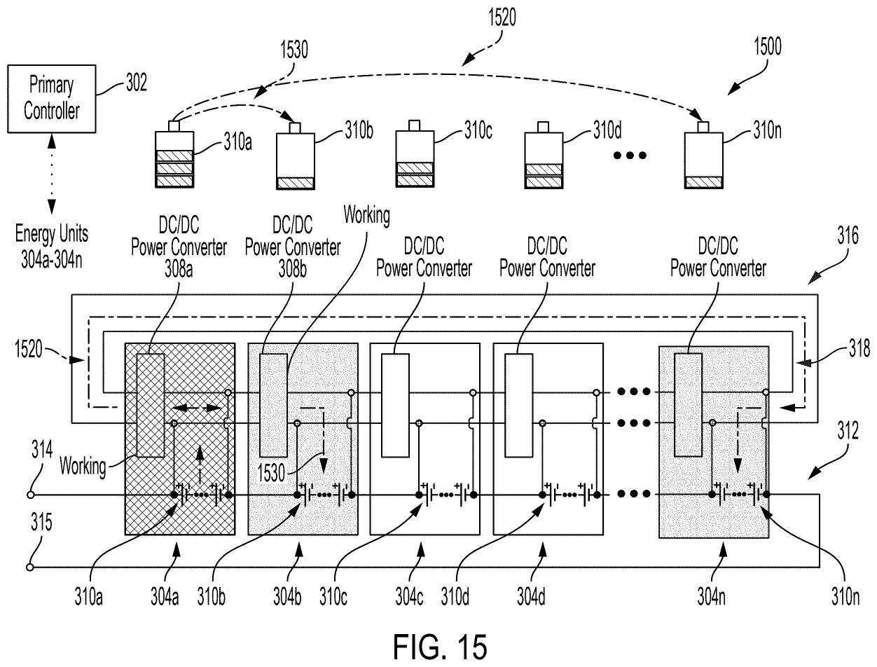

In various examples, the primary controller 202 may execute the process 500 and perform a balancing operation on a one-to-multiple basis. In a one-to-multiple configuration, the primary controller 202 identifies one or more discharging energy units and, for each discharging energy unit, multiple charging energy units. For example, the primary controller 202 may identify one discharging energy unit and two or more corresponding charging energy units that the discharging energy unit provides power to, or may identify two discharging energy units and two or more corresponding charging energy units for each discharging energy unit, and so forth. Examples of the one-to-multiple configuration are provided below with respect to FIGS. 15-17 and 21-26.

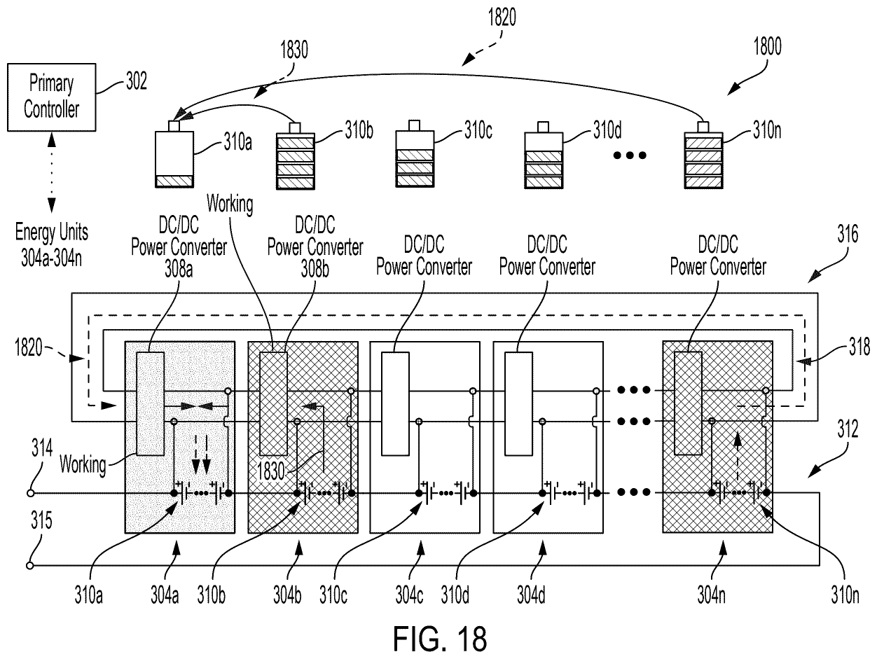

In at least one example, the primary controller 202 may execute process 500 and perform a balancing operation on a multiple-to-one basis. In a multiple-to-one configuration, the primary controller 202 identifies one or more charging energy units and, for each charging energy unit, multiple discharging energy units. For example, the primary controller 202 may identify one charging energy unit and two or more corresponding discharging energy units that provide power to the charging energy unit, or may identify two discharging energy units and two or more corresponding charging energy units for each discharging energy unit, and so forth. Examples of the multiple-to-one configuration are provided below with respect to FIGS. 18-20.

In various examples, the primary controller 202 may execute process 500 and perform a balancing operation on a multiple-to-multiple basis. In a multiple-to-multiple configuration, the primary controller 202 identifies multiple discharging energy units and, for each set of multiple discharging units, multiple charging energy units. For example, the primary controller 202 may identify two or more discharging energy units and two or more corresponding charging energy units that the discharging energy units provide power to.

In at least one example, the primary controller 202 may execute process 500 and perform a balancing operation on several of the bases discussed above. For example, the primary controller 202 may identify a first and a second energy unit with which to perform a balancing operation on a one-to-one basis, and may identify a third, fourth, and fifth energy unit with which to perform a balancing operation on a one-to-multiple basis. In various examples, any combination of the bases discussed above may be implemented to perform the balancing operation.

FIG. 6 illustrates a schematic diagram of an ESS 600 having the same topology as the ESS 300 executing a balancing operation in a one-to-one configuration according to an example. The primary controller 302 may execute process 500 and determine that a difference in SOC between the first battery module 310a and the Nth battery module 310n exceeds the threshold difference at act 506. The first battery module 310a may have the least remaining charge (indicated by the smallest SOC value) of all of the battery modules 310a-310n, and the Nth battery module 310n may have the most remaining charge (indicated by the largest SOC value) of all of the battery modules 310a-310n.

In executing act 508, the primary controller 302 may identify one or more potential power paths from the Nth battery module 310n to the first battery module 310a. For example, a first power path (extending towards the “left-hand” side of the Nth energy unit 304n in FIG. 6) may extend from the Nth battery module 310n through the fourth energy unit 304d, the third energy unit 304c, the second energy unit 304b, and finally to the first energy unit 304a. A second power path 620 (extending towards the “right-hand” side of the Nth energy unit 304n in FIG. 6) may extend from the Nth battery module 310n directly to the first energy unit 304a. The primary controller 302 may determine that the second power path 620 is the most efficient power path because the second power path 620 does not pass through any intermediate power converters, whereas the first power path passes through at least three intermediate DC/DC power converters (including, for example, the power converters 308b, 308c, and 308d).

As illustrated in FIG. 6, the Nth energy unit 304n is directly coupled to the first energy unit 304a via the power connections 316, 318. More particularly, the Nth battery module 310n is directly coupled to the first DC/DC power converter 308a via the power connections 316, 318. In executing act 510, the primary controller 302 controls the first DC/DC power converter 308a to draw power from the Nth battery module 310n, convert the drawn power (for example, converting DC power to converted DC power), and provide the converted power to the first battery module 310a to charge the first battery module 310a. To convert the drawn power, the primary controller 202 may send control signals to operate the DC/DC power converter 308a to buck or boost the output voltage of the first DC/DC power converter 308a to a desired voltage. The desired voltage may be a value greater than the voltage of the first battery module 310a so that power can flow from the Nth battery module 310n to the first battery module 310a through the first power converter 308a via the power path 620. In this example, the primary controller 302 may only control the first power converter 308a to convert power (denoted as “working”), while the remaining power converters 308b-308n may not be converting power.

As discussed above, in some examples the primary controller 302 may directly control one or more of the power converters 308a-308n. For example, the primary controller 202 may directly provide one or more switching signals to one or more switches in the DC/DC power converters 308a-308n. In other examples, the primary controller 302 may send instructions to one or more of the secondary controllers 206 to provide the switching signals. For example, the primary controller 302 may instruct the first secondary controller 206a to provide switching signals to the first DC/DC power converter 208a to convert power.

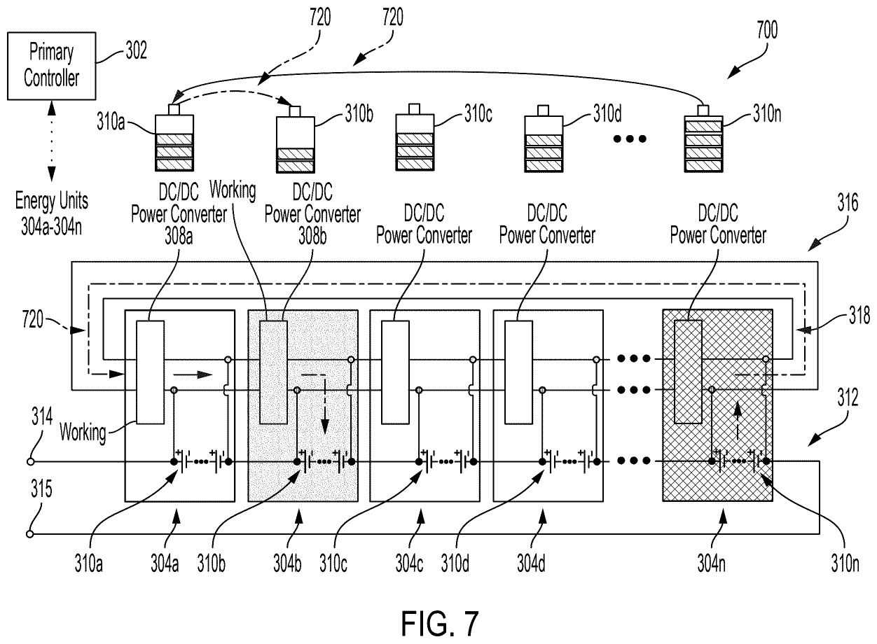

FIG. 7 illustrates a schematic diagram of an ESS 700 having the same topology as the ESS 300 and executing a one-to-one balancing process between two battery modules according to another example. The primary controller 302 may execute the process 500 and determine that a difference in SOC between the second battery module 310b and the Nth battery module 310n exceeds the threshold difference at act 506. The second battery module 310b may have the least remaining charge (indicated by the smallest SOC value) of all of the battery modules 310a-310n, and the Nth battery module 310n may have the most remaining charge (indicated by the largest SOC value) of all of the battery modules 310a-310n. In executing act 508, the primary controller 302 may identify one or more potential power paths from the Nth battery module 310n to the second battery module 310b. For example, the primary controller 302 may determine that a power path 720 is the most efficient power path because the power path 720 passes through the lowest number of DC/DC power converters.

For example, the Nth battery module 310n is directly coupled to the first DC/DC power converter 308a via the power connections 316, 318. In executing act 510, the primary controller 302 controls the first DC/DC power converter 308a and the second DC/DC power converter 308b to draw power from the Nth battery module 310n, convert the drawn power (for example, converting DC power to converted DC power), and provide the converted power to the second battery module 310b to charge the second battery module 310b. To convert the drawn power, the primary controller 302 may send control signals to operate the DC/DC power converters 308a, 308b to buck or boost the output voltages of the DC/DC power converters 308a, 308b to desired voltages. The desired voltages may be greater than the voltage of the second battery module 310b so that power can flow from the Nth battery module 310n to the second battery module 310b through the DC/DC power converters 308a, 308b via the power path 720. In this example, the primary controller 302 may only control the DC/DC power converters 308a, 308b to convert power (denoted as “working”), while the remaining power converters 308c-308n may not be converting power.

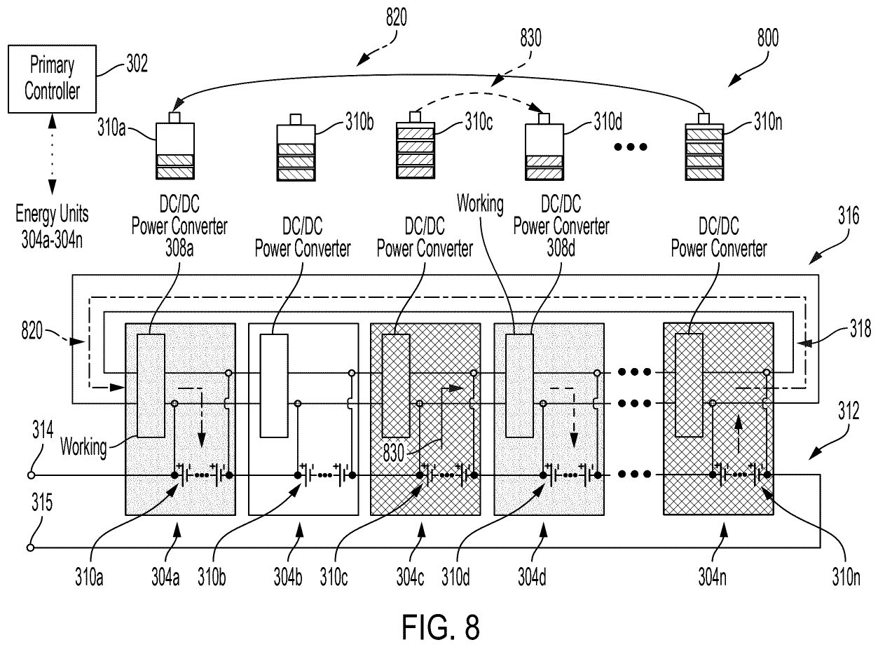

FIG. 8 illustrates a schematic diagram of an ESS 800 having the same topology as the ESS 300 and executing a one-to-one balancing process for two separate pairs of battery modules according to another example. The primary controller 302 may execute the process 500 and determine that a difference in SOC between the first battery module 310a and the Nth battery module 310n exceeds the threshold difference at act 506, and a difference in SOC between the third battery module 310c and the fourth battery module 310d exceeds the threshold difference at act 506.

The battery modules 310a, 310d may have the least remaining charge (indicated by the smallest SOC value[s]) of all of the battery modules 310a-310n, and the battery modules 310c, 310n may have the most remaining charge (indicated by the largest SOC value[s]) of all of the battery modules 310a-310n. The battery modules 310a, 310d may thus be considered charging battery modules, and the battery modules 310c, 310n may thus be considered discharging battery modules. In executing act 508, the primary controller 302 may identify one or more potential power paths from the discharging battery modules 310c, 310n to the charging battery modules 310a, 310d. The primary controller 302 may determine that the most efficient charging scheme includes a first power path 820 from the Nth battery module 310n to the first battery module 310a and a second power path 830 from the third battery module 310c to the fourth battery module 310d.

For example, the Nth battery module 310n is directly coupled to the first DC/DC power converter 308a via the power connections 316, 318. Although the third energy unit 304c could, as a discharging energy unit, provide power to the first energy unit 304a via the second energy unit 304b, doing so would be less efficient than if the Nth energy unit 304n provides power to the first energy unit 304a.

In executing act 510, the primary controller 302 controls the first DC/DC power converter 308a to draw power from the Nth battery module 310n, convert the drawn power (for example, converting DC power to converted DC power), and provide the converted power to the first battery module 310a to charge the first battery module 310a through the first DC/DC power converter 308a via the first power path 820. To convert the drawn power, the primary controller 302 may send control signals to operate the first DC/DC power converter 308a to buck or boost the output voltage of the first DC/DC power converter 308a to a desired voltage. The desired voltage may be a value greater than the voltage of the first battery module 310a so that power can flow from the Nth battery module 310n to the first battery module 310a through the first DC/DC power converter 308a via the first power path 820.

Meanwhile, in executing act 510, the primary controller 302 also controls the fourth DC/DC power converter 308d to draw power from the third battery module 310c, convert the drawn power (for example, converting DC power to converted DC power), and provide the converted power to the fourth battery module 310d to charge the fourth battery module 310d through the fourth DC/DC power converter 308d via the second power path 830. In this example, the primary controller 302 may only control the DC/DC power converters 308a, 308d to convert power (denoted as “working”), while the remaining power converters may not be converting power.

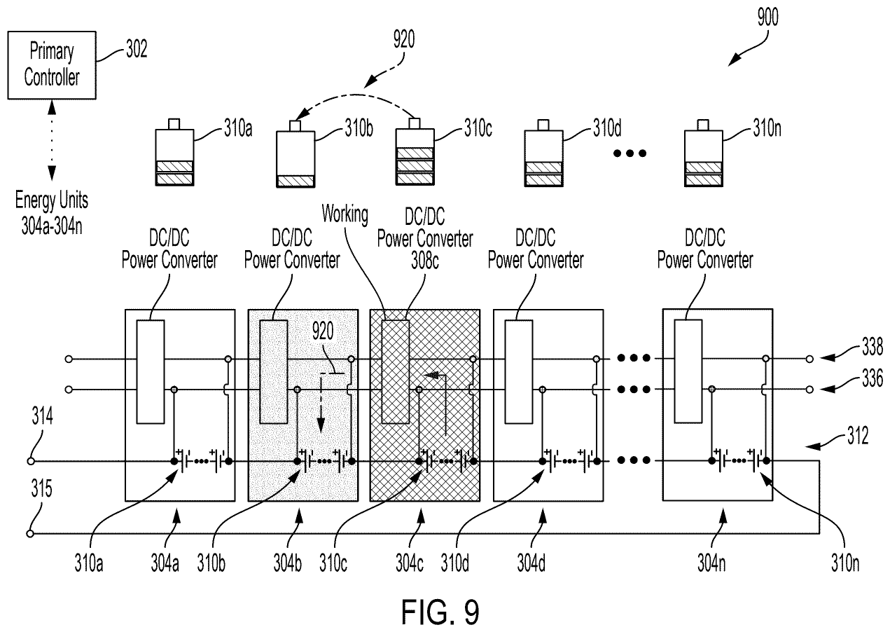

FIG. 9 illustrates a schematic diagram of an ESS 900 having the same topology as the ESS 320 and executing a one-to-one balancing process between two battery modules according to an example. The primary controller 302 may execute the process 500 and determine that a difference in SOC between the second battery module 310b and the third battery module 310c exceeds the threshold difference at act 506. The second battery module 310b may have the least remaining charge (indicated by the smallest SOC value) of all of the battery modules 310a-310n, and the third battery module 310c may have the most remaining charge (indicated by the largest SOC value) of all of the battery modules 310a-310n. In executing act 508, the primary controller 302 may identify one or more potential power paths from the third battery module 310c to the second battery module 310b. For example, the primary controller 302 may determine that the power path 920 is the most efficient power path because the power path 920 passes through the lowest number of DC/DC power converters.

For example, the Nth battery module 310n is not directly coupled to the first DC/DC power converter 308a via the power connections 336, 338. In executing act 510, the primary controller 302 controls the third DC/DC power converter 308c to draw power from the third battery module 310c, convert the drawn power (for example, converting DC power to converted DC power), and provide the converted power to the second battery module 310b to charge the second battery module 310b. To convert the drawn power, the primary controller 302 may send control signals to operate the third DC/DC power converter 308c to buck or boost the output voltage of the third DC/DC power converter 308c to a desired voltage. The desired voltage may be a value greater than the voltage of the second battery module 310b so that power can flow from the third battery module 310c to the second battery module 310b through the third DC/DC power converter 308c via the power path 920. In this example, the primary controller 302 may only control the third DC/DC power converter 308c to convert power (denoted as “working”), while the remaining power converters may not be converting power.

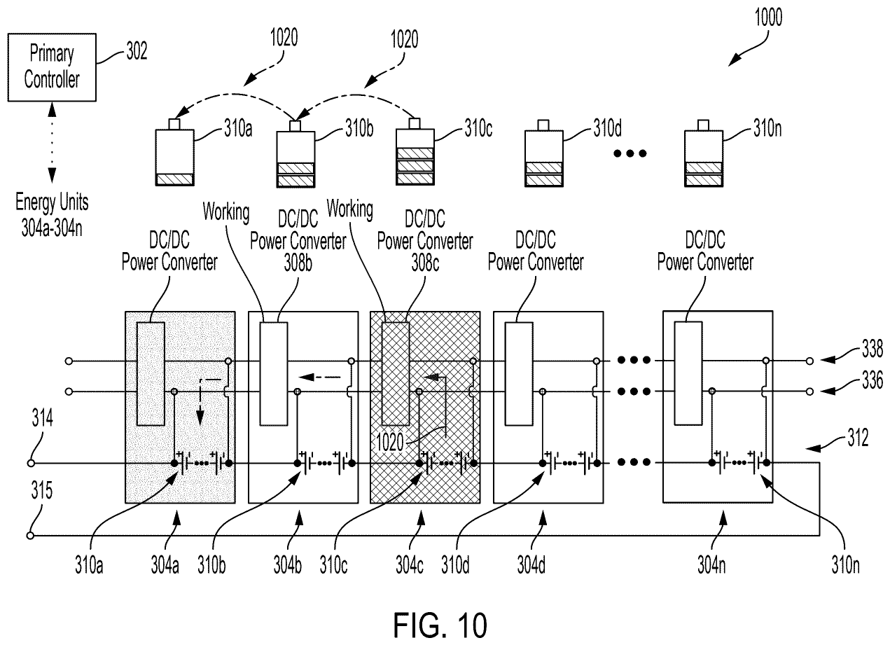

FIG. 10 illustrates a schematic diagram of an ESS 1000 having the same topology as the ESS 320 and executing a one-to-one balancing process between two battery modules according to another example. The primary controller 302 may execute the process 500 and determine that a difference in SOC between the first battery module 310a and the third battery module 310c exceeds the threshold difference at act 506. The first battery module 310a may have the least remaining charge (indicated by the smallest SOC value) of all of the battery modules 310a-310n, and the third battery module 310c may have the most remaining charge (indicated by the largest SOC value) of all of the battery modules 310a-310n. In executing act 508, the primary controller 302 may identify one or more potential power paths from the third battery module 310c to the first battery module 310a. The primary controller 302 may determine that power path 1020 is the most efficient power path because power path 1020 passes through the lowest number of DC/DC power converters.

For example, the Nth battery module 310n is not directly coupled to the first DC/DC power converter 308a via the power connections 336, 338. In executing act 510, the primary controller 302 controls the DC/DC power converters 308b, 308c to draw power from the third battery module 310c, convert the drawn power (for example, converting DC power to converted DC power), and provide the converted power to the first battery module 310a to charge the first battery module 310a through the power path 1020. To convert the drawn power, the primary controller 302 may send control signals to operate the DC/DC power converters 308b, 308c to buck or boost the output voltages of the DC/DC power converters 308b, 308c to desired voltages. The desired voltages may be greater than the voltage of the first battery module 310a so that power can flow from the third battery module 310c to the first battery module 310a through the DC/DC power converters 308b, 308c via the power path 1020. In this example, the primary controller 302 may only control the DC/DC power converters 308b, 308c to convert power (denoted as “working”), while the remaining power converters may not be converting power.

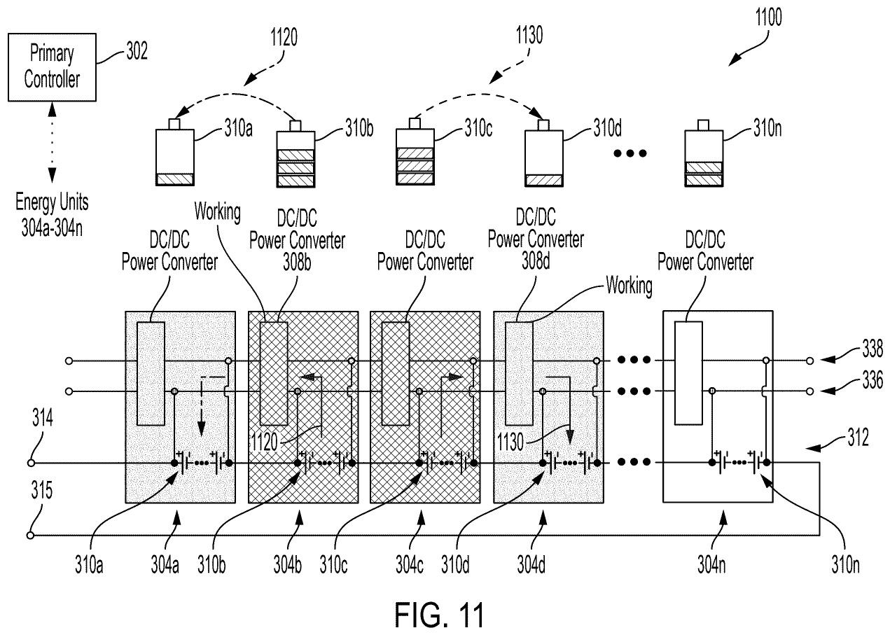

FIG. 11 illustrates a schematic diagram of an ESS 1100 having the same topology as the ESS 320 and executing a one-to-one balancing process for two separate pairs of battery modules according to another example. The primary controller 302 may execute the process 500 and determine that a difference in SOC between the first battery module 310a and the second battery module 310b exceeds the threshold difference at act 506, and a difference in SOC between the third battery module 310c and the fourth battery module 310d exceeds the threshold difference at act 506. The battery modules 310a, 310d may have the least remaining charge (indicated by the smallest SOC value[s]) of all of the battery modules 310a-310n, and the battery modules 310b, 310c may have the most remaining charge (indicated by the largest SOC value[s]) of all of the battery modules 310a-310n. The battery modules 310b, 310c may thus be considered discharging battery modules, and the battery modules 310a, 310d may thus be considered charging battery modules. In executing act 508, the primary controller 302 may identify one or more potential power paths from the discharging battery modules 310b, 310c to the charging battery modules 310a, 310d. The primary controller 302 may determine that the most efficient charging scheme includes a first power path 1120 from the second battery module 310b to the first battery module 310a and a second power path 1130 from the third battery module 310c to the fourth battery module 310d.

For example, the Nth battery module 310n is not directly coupled to the first DC/DC power converter 308a via the power connections 336, 338. In executing act 510, the primary controller 302 controls the second DC/DC power converter 308b to draw power from the second battery module 310b, convert the drawn power (for example, converting DC power to converted DC power), and provide the converted power to the first battery module 310a to charge the first battery module 310a through the second DC/DC power converter 308b via the first power path 1120. To convert the drawn power, the primary controller 302 may send control signals to operate the second DC/DC power converter 308b to buck or boost the output voltage of the second DC/DC power converter 308b to a desired voltage. The desired voltage may be a value greater than the voltage of the first battery module 310a so that power can flow from the second battery module 310b to the first battery module 310a through the second DC/DC power converter 308b. Meanwhile, in executing act 510, the primary controller 302 also controls the fourth DC/DC power converter 308d to draw power from the third battery module 310c, convert the drawn power (for example, converting DC power to converted DC power), and provide the converted power to the fourth battery module 310d to charge the fourth battery module 310d through the fourth DC/DC power converter 308d via the second power path 1130. In this example, the primary controller 302 may only control the DC/DC power converters 308b, 308d to convert power (denoted as “working”), while the remaining power converters may not be converting power.

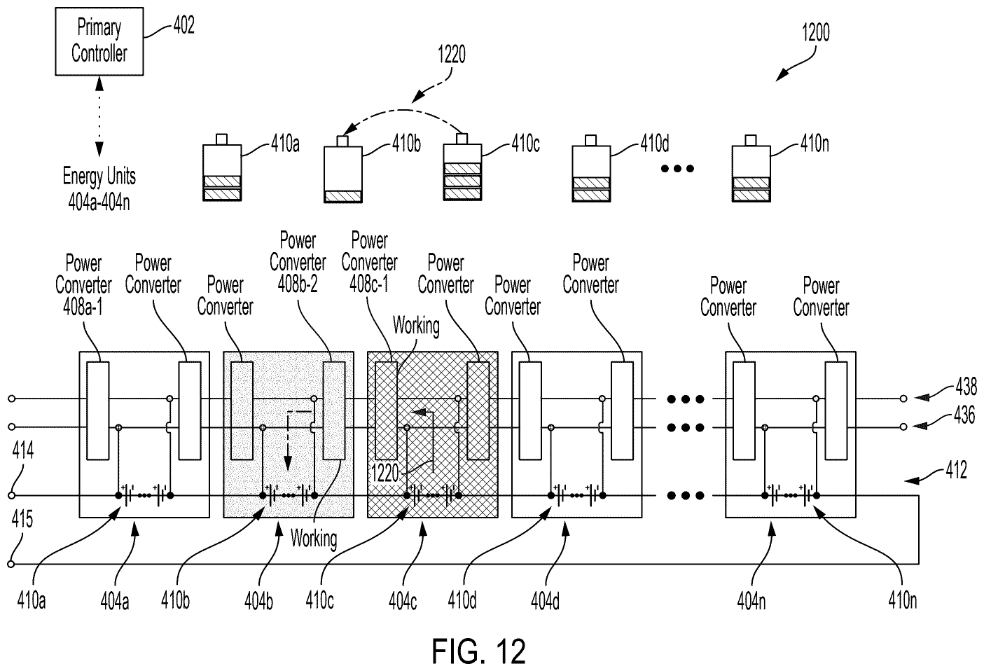

FIG. 12 illustrates a schematic diagram of an ESS 1200 having the same topology as the ESS 420 and executing a one-to-one balancing process between two battery modules according to an example. The primary controller 402 may execute the process 500 and determine that a difference in SOC between the second battery module 410b and the third battery module 410c exceeds the threshold difference at act 506. The second battery module 410b may have the least remaining charge (indicated by the smallest SOC value) of all of the battery modules 410a-410n, and the third battery module 410c may have the most remaining charge (indicated by the largest SOC value) of all of the battery modules 410a-410n. In executing act 508, the primary controller 402 may identify one or more potential power paths from the third battery module 410c to the second battery module 410b. The primary controller 402 may determine that the power path 1220 is the most efficient power path because the power path 1220 passes through the lowest number of (AC/DC or DC/DC) power converters.

For example, the Nth battery module 410n is not directly coupled to the first power converter 408a-1 via the power connections 436, 438. In executing act 510, the primary controller 402 controls the power converters 408b-2, 408c-1 to draw power from the third battery module 410c, convert the drawn power (for example, converting DC power to AC power and then to converted DC power), and provide the converted power to the second battery module 410b to charge the second battery module 410b. To convert the drawn power, the primary controller 402 may send control signals to operate the power converters 408b-2, 408c-1 to buck or boost the output voltages of the power converters 408b-2, 408c-1 to desired voltages. The desired voltages may be greater than the voltage of the second battery module 410b so that power can flow from the third battery module 410c to the battery module 410b through the power converters 408b-2, 408c-1 via the power path 1220. In this example, the primary controller 402 may only control the power converters 408b-2, 408c-1 to convert power (denoted as “working”), while the remaining power converters may not be converting power.

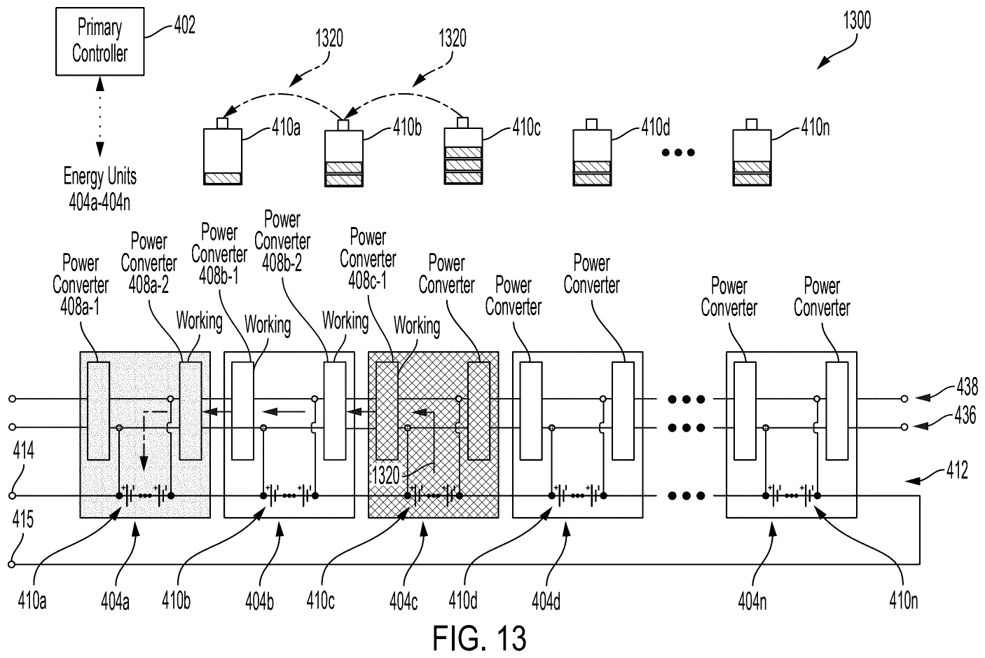

FIG. 13 illustrates a schematic diagram of an ESS 1300 having the same topology as the ESS 420 and executing a one-to-one balancing process between two battery modules according to another example. The primary controller 402 may execute the process 500 and determine that a difference in SOC between the first battery module 410a and the third battery module 410c exceeds the threshold difference at act 506. The first battery module 410a may have the least remaining charge (indicated by the smallest SOC value) of all of the battery modules 410a-410n, and the third battery module 410c may have the most remaining charge (indicated by the largest SOC value) of all of the battery modules 410a-410n. In executing act 508, the primary controller 402 may identify one or more potential power paths from the third battery module 410c to the first battery module 410a. The primary controller 402 may determine that the power path 1320 is the most efficient power path because the power path 1320 passes through the lowest number of (AC/DC or DC/DC) power converters.

For example, the Nth battery module 410n is not directly coupled to the first power converter 408a-1 via the power connections 436, 438. In executing act 510, the primary controller 402 controls the power converters 408a-2, 408b-1, 408b-2, 408c-1 to draw power from the third battery module 410c, convert the drawn power (for example, converting DC power to converted DC power), and provide the converted power to the first battery module 410a to charge the first battery module 410a. To convert the drawn power, the primary controller 402 may send control signals to operate the power converters 408a-2, 408b-1, 408b-2, 408c-1 to buck or boost the output voltages of the power converters 408a-2, 408b-1, 408b-2, 408c-1 to desired voltages. The desired voltages may be greater than the voltage of the first battery module 410a so that power can flow from the third battery module 410c to the first battery module 410a through the power converters 408a-2, 408b-1, 408b-2, 408c-1 via the power path 1320. In this example, the primary controller 402 may only control the power converters 408a-2, 408b-1, 408b-2, 408c-1 to convert power (denoted as “working”), while the remaining power converters may not be converting power.

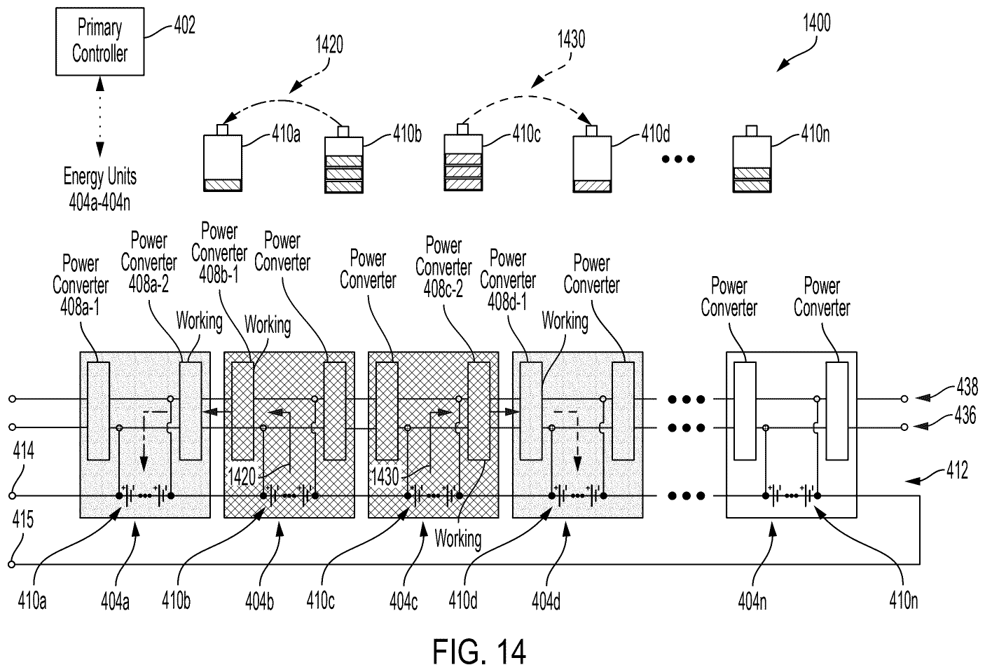

FIG. 14 illustrates a schematic diagram of an ESS 1400 having the same topology as the ESS 420 and executing a one-to-one balancing process for two separate pairs of battery modules according to another example. The primary controller 402 may execute the process 500 and determine that a difference in SOC between the first battery module 410a and the second battery module 410b exceeds the threshold difference at act 506, and a difference in SOC between the third battery module 410c and the fourth battery module 410d exceeds the threshold difference at act 506. The battery modules 410a, 410d may have the least remaining charge (indicated by the smallest SOC value[s]) of all of the battery modules 410a-410n, and the battery modules 410b, 410c may have the most remaining charge (indicated by the largest SOC value[s]) of all of the battery modules 410a-410n. The battery modules 410b, 410c may thus be considered discharging battery modules, and the battery modules 410a, 410d may thus be considered charging battery modules. In executing act 508, the primary controller 402 may identify one or more potential power paths from the discharging battery modules 410b, 410c to the charging battery modules 410a, 410d. The primary controller 402 may determine that the most efficient charging scheme includes a first power path 1420 from the second battery module 410b to the first battery module 410a and a second power path 1430 from the third battery module 410c to the fourth battery module 410d.

For example, the Nth battery module 410n is not directly coupled to the first power converter 408a-1 via the power connections 436, 438. In executing act 510, the primary controller 402 controls the power converters 408a-2, 408b-1 to draw power from the second battery module 410b, convert the drawn power (for example, converting DC power to AC power and then to converted DC power), and provide the converted power to the first battery module 410a to charge the first battery modules 410a. To convert the drawn power, the primary controller 402 may send control signals to operate the power converters 408a-2, 408b-1 to buck or boost the output voltages of the power converters 408a-2, 408b-1 to desired voltages. The desired voltages may be greater than the voltage of the first battery module 410a so that power can flow from the second battery module 410b to the first battery module 410a through the power converters 408a-2, 408b-1 via the first power path 1420. Meanwhile, in executing act 510, the primary controller 402 controls the power converters 408c-2, 408d-1 to draw power from the third battery module 410c, convert the drawn power (for example, converting DC power to AC power and then to converted DC power), and provide the converted DC power to the fourth battery modules 410d to charge the fourth battery module 410d via the second power path 1430. In this example, the primary controller 402 may only control the power converters 408a-2, 408b-1, 408c-2, 408d-1 to convert power (denoted as “working”), while the remaining power converters may not be converting power.

FIG. 15 illustrates a schematic diagram of an ESS 1400 having the same topology as the ESS 300 and executing a one-to-multiple balancing process between battery modules according to an example. The primary controller 302 may execute the process 500 and determine that a difference in SOC between the first battery module 310a and the Nth battery module 310n exceeds the threshold difference at act 506, and a difference in SOC between the first battery module 310a and the second battery module 310b exceeds the threshold difference at act 506. The battery modules 310b, 310n may have the least remaining charge (indicated by the smallest SOC value[s]) of all of the battery modules 310a-310n, and the battery module 310a may have the most remaining charge (indicated by the largest SOC value) of all of the battery modules 310a-310n. The first battery module 310a may thus be considered a discharging battery module, and the battery modules 310b, 310n may thus be considered charging battery modules. In executing act 508, the primary controller 302 may identify one or more potential power paths from the discharging battery module 310a to the charging battery modules 310b, 310n. The primary controller 302 may determine that the most efficient charging scheme includes a first power path 1520 from the first battery module 310a to the Nth battery module 310n and a second power path 1530 from the first battery module 310a to the second battery module 310b.

For example, the Nth battery module 310n is directly coupled to the first DC/DC power converter 308a via the power connections 316, 318. In executing act 510, the primary controller 302 controls the first DC/DC power converter 308a to draw power from the first battery module 310a, convert the drawn power (for example, converting DC power to converted DC power), and provide the converted power to the Nth battery module 310n to charge the Nth battery module 310n. To convert the drawn power, the primary controller 302 may send control signals to operate the first DC/DC power converter 308a to buck or boost the output voltage of the first DC/DC power converter 308a to a desired voltage. The desired voltage may be greater than the voltage of the Nth battery module 310n so that power can flow from the first battery module 310a to the Nth battery module 310n through the first DC/DC power converter 308a via the first power path 1520. Meanwhile, in executing act 510, the primary controller 302 controls the second DC/DC power converter 308b to draw power from the first battery module 310a, convert the drawn power (for example, converting DC power to converted DC power), and provide the converted power to the second battery module 310b to charge the second battery module 310b via the second power path 1530. In this example, the primary controller 302 may only control the DC/DC power converters 308a, 308b to convert power (denoted as “working”), while the remaining power converters 308c-308n may not be converting power.

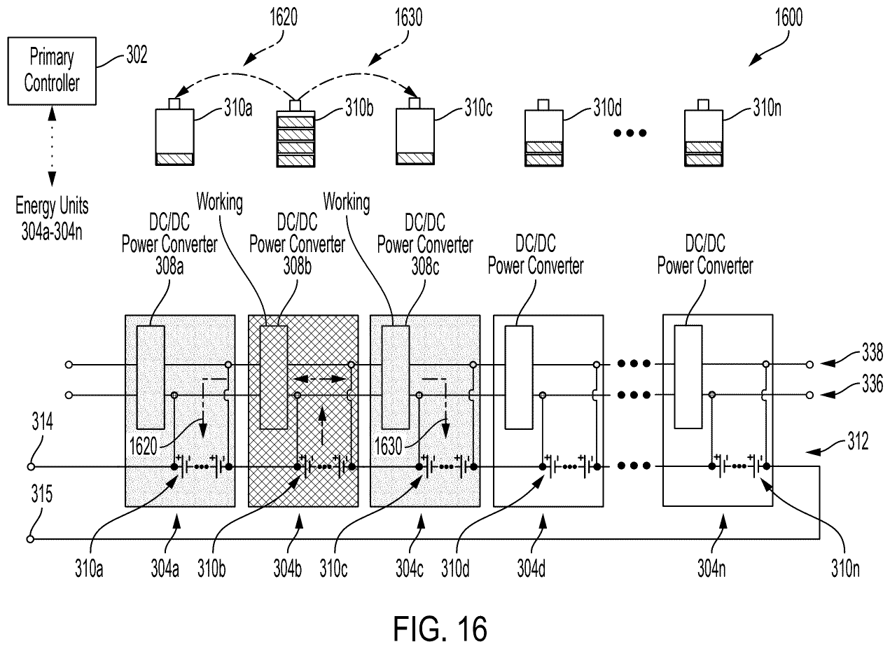

FIG. 16 illustrates a schematic diagram of an ESS 1600 having the same topology as the ESS 320 and executing a one-to-multiple balancing process between battery modules according to an example. The primary controller 302 may execute the process 500 and determine that a difference in SOC between the first battery module 310a and the second battery module 310b exceeds the threshold difference at act 506, and a difference in SOC between the second battery module 310b and the third battery module 310c exceeds the threshold difference at act 506. The battery modules 310a, 310c may have the least remaining charge (indicated by the smallest SOC value[s]) of all of the battery modules 310a-310n, and the second battery module 310b may have the most remaining charge (indicated by the largest SOC value) of all of the battery modules 310a-310n. The second battery module 310b may thus be considered a discharging battery module, and the battery modules 310a, 310c may thus be considered charging battery modules. In executing act 508, the primary controller 302 may identify one or more potential power paths from the discharging battery module 310b to the charging battery modules 310a, 310c. The primary controller 302 may determine that the most efficient charging scheme includes a first power path 1620 from the second battery module 310b to the first battery module 310a and a second power path 1630 from the second battery module 310b to the third battery module 310c.

For example, the Nth battery module 310n is not directly coupled to the first DC/DC power converter 308a via the power connections 336, 338. In executing act 510, the primary controller 302 controls the second DC/DC power converter 308b to draw power from the second battery module 310b, convert the drawn power (for example, converting DC power to converted DC power), and provide the converted power to the first battery module 310a to charge the first battery module 310a. To convert the drawn power, the primary controller 302 may send control signals to operate the second DC/DC power converter 308b to buck or boost the output voltage of the second DC/DC power converter 308b to a desired voltage. The desired voltage may be greater than the voltage of the first battery module 310a so that power can flow from the second battery module 310b to the first battery module 310a through the second DC/DC power converter 308b via the first power path 1620. Meanwhile, in executing act 510, the primary controller 302 controls the third DC/DC power converter 308c to draw power from the second battery module 310b, convert the drawn power (for example, converting DC power to converted DC power), and provide the converted power to the third battery module 310c to charge the third battery module 310c via the second power path 1630. In this example, the primary controller 302 may only control the DC/DC power converters 308b, 308c to convert power (denoted as “working”), while the remaining power converters may not be converting power.

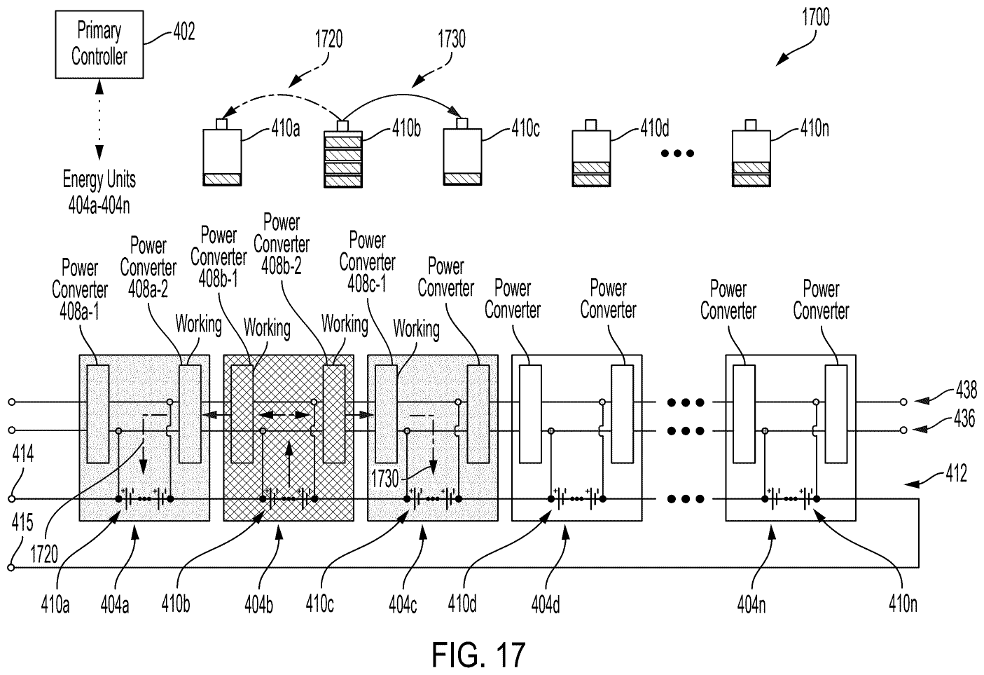

FIG. 17 illustrates a schematic diagram of an ESS 1700 having the same topology as the ESS 420 and executing a one-to-multiple balancing process between battery modules according to an example. The primary controller 402 may execute the process 500 and determine that a difference in SOC between the second battery module 410b and the first battery module 410a exceeds the threshold difference at act 506, and a difference in SOC between the second battery module 410b and the third battery module 410c exceeds the threshold difference at act 506. The battery modules 410a, 410c may have the least remaining charge (indicated by the smallest SOC value[s]) of all of the battery modules 410a-410n, and the battery module 410b may have the most remaining charge (indicated by the largest SOC value) of all of the battery modules 410a-410n. The second battery module 410b may thus be considered a discharging battery module, and the battery modules 410a, 410c may thus be considered charging battery modules. In executing act 508, the primary controller 402 may identify one or more potential power paths from the discharging battery module 410b to the charging battery modules 410a, 410c. The primary controller 402 may determine that the most efficient charging scheme includes a first power path 1720 from the second battery module 410b to the first battery module 410a and a second power path 1730 from the second battery module 410b to the third battery module 410c.

For example, the Nth battery module 410n is not directly coupled to the first power converter 408a-1 via the power connections 436, 438. In executing act 510, the primary controller 402 controls the power converters 408a-2, 408b-1 to draw power from the second battery module 410b, convert the drawn power (for example, converting DC power to AC power and then to converted DC power), and provide the converted power to the first battery module 410a to charge the first battery module 410a. To convert the drawn power, the primary controller 402 may send control signals to operate the power converters 408a-2, 408b-1 to buck or boost the output voltages of the power converters 408a-2, 408b-1 to desired voltages. The desired voltages may be greater than the voltage of the first battery module 410a so that power can flow from the second battery module 410b to the first battery module 410a through the power converters 408a-2, 408b-1 via the first power path 1720. Meanwhile, in executing act 510, the primary controller 402 controls the power converters 408b-2, 408c-1 to draw power from the second battery module 410b, convert the drawn power (for example, converting DC power to AC power and then to converted DC power), and provide the converted power to the third battery module 410c to charge the third battery module 410c via the second power path 1730. In this example, the primary controller 402 may only control the power converters 408a-2, 408b-1, 408b-2, 408c-1 to convert power (denoted as “working”), while the remaining power converters may not be converting power.

FIG. 18 illustrates a schematic diagram of an ESS 1800 having the same topology as the ESS 300 and executing a multiple-to-one balancing process between battery modules according to an example. The primary controller 302 may execute the process 500 and determine that a difference in SOC between the first battery module 310a and the Nth battery module 310n exceeds the threshold difference at act 506, and a difference in SOC between the first battery module 310a and the second battery module 310b exceeds the threshold difference at act 506. The first battery module 310a may have the least remaining charge (indicated by the smallest SOC value) of all of the battery modules 310a-310n, and the battery modules 310b, 310n may have the most remaining charge (indicated by the largest SOC value[s]) of all of the battery modules 310a-310n. The battery modules 310b, 310n may thus be considered discharging battery modules, and the first battery module 310a may thus be considered a charging battery module. In executing act 508, the primary controller 302 may identify one or more potential power paths from the discharging battery modules 310b, 310n to the charging battery module 310a. The primary controller 302 may determine that the most efficient charging scheme includes a first power path 1820 from the Nth battery module 310n to the first battery module 310a and a second power path 1830 from the second battery module 310b to the first battery module 310a.

For example, the Nth battery module 310n is directly coupled to the first DC/DC power converter 308a via the power connections 316, 318. In executing act 510, the primary controller 302 controls the first DC/DC power converter 308a to draw power from the Nth battery module 310n, convert the drawn power (for example, converting DC power to converted DC power), and provide the converted power to the first battery module 310a to charge the first battery module 310a. To convert the drawn power, the primary controller 302 may send control signals to operate the first DC/DC power converter 308a to buck or boost the output voltage of the first DC/DC power converter 308a to a desired voltage. The desired voltage may be greater than the voltage of the first battery module 310a so that power can flow from the Nth battery module 310n to the first battery module 310a through the first DC/DC power converter 308a via the first power path 1820. Meanwhile, in executing act 510, the primary controller 302 controls the second DC/DC power converter 308b to draw power from the second battery module 310b, convert the drawn power (for example, converting DC power to converted DC power), and provide the converted power to the first battery module 310a to charge the first battery module 310a via the second power path 1830. In this example, the primary controller 302 may only control the DC/DC power converters 308a, 308b to convert power (denoted as “working”), while the remaining power converters 308c-308n may not be converting power.

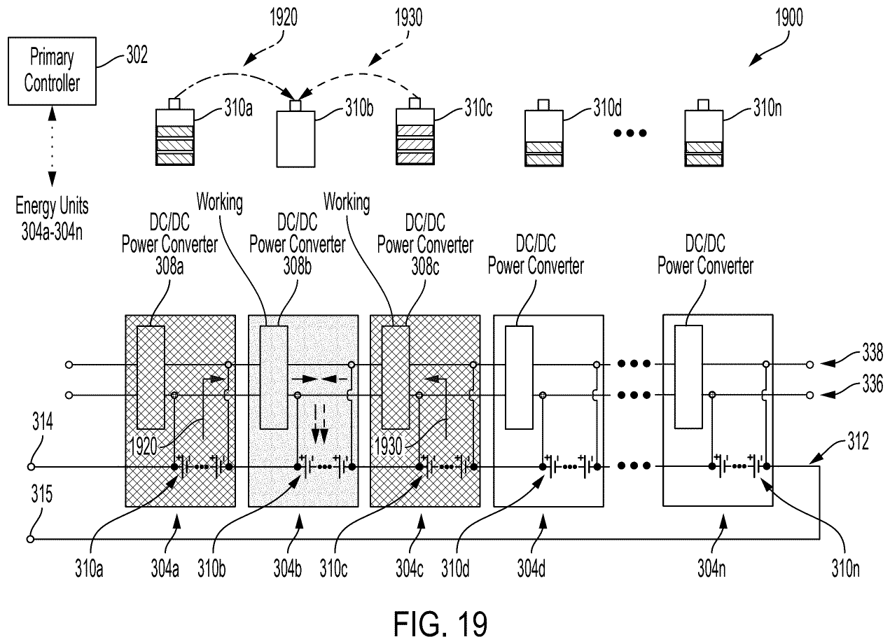

FIG. 19 illustrates a schematic diagram of an ESS 1900 having the same topology as the ESS 320 and executing a multiple-to-one balancing process between battery modules according to an example. The primary controller 302 may execute the process 500 and determine that a difference in SOC between the second battery module 310b and the first battery module 310a exceeds the threshold difference at act 506, and a difference in SOC between the second battery module 310b and the third battery module 310c exceeds the threshold difference at act 506. The second battery module 310b may have the least remaining charge (indicated by the smallest SOC value) of all of the battery modules 310a-310n, and the battery modules 310a, 310c may have the most remaining charge (indicated by the largest SOC value[s]) of all of the battery modules 310a-310n. The battery modules 310a, 310c may thus be considered discharging battery modules, and the second battery module 310b may thus be considered a charging battery module. In executing act 508, the primary controller 302 may identify one or more potential power paths from the discharging battery modules 310a, 310c to the charging battery module 310b. The primary controller 302 may determine that the most efficient charging scheme includes a first power path 1920 from the first battery module 310a to the second battery module 310b and a second power path 1930 from the third battery module 310c to the second battery module 310b.

For example, the Nth battery module 310n is not directly coupled to the first DC/DC power converter 308a via the power connections 336, 338. In executing act 510, the primary controller 302 controls the second DC/DC power converter 308b to draw power from the first battery module 310a, convert the drawn power (for example, converting DC power to converted DC power), and provide the converted power to the second battery module 310b to charge the second battery module 310b. To convert the drawn power, the primary controller 302 may send control signals to operate the second DC/DC power converter 308b to buck or boost the output voltage of the second DC/DC power converter 308b to a desired voltage. The desired voltage may be greater than the voltage of the second battery module 310b so that power can flow from the first battery module 310a to the second battery module 310b through the second DC/DC power converter 308b via the first power path 1920. Meanwhile, in executing act 510, the primary controller 302 controls the third DC/DC power converter 308c to draw power from the third battery module 310c, convert the drawn power (for example, converting DC power to converted DC power), and provide the converted power to the second battery module 310b to charge the second battery module 310b via the second power path 1930. In this example, the primary controller 302 may only control the DC/DC power converters 308b, 308c to convert power (denoted as “working”), while the remaining power converters may not be converting power.

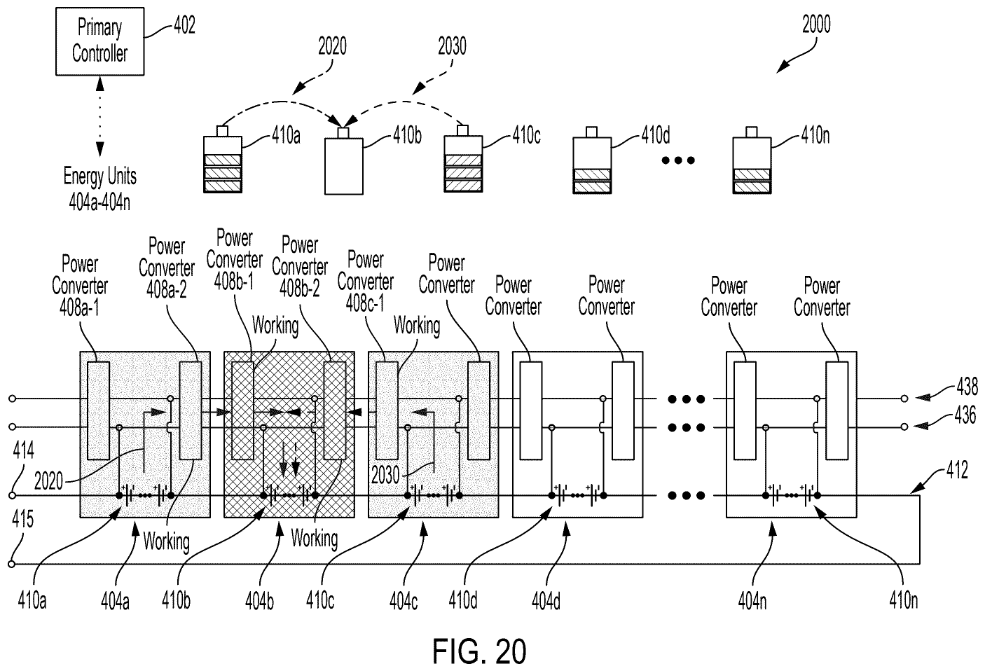

FIG. 20 illustrates a schematic diagram of an ESS 2000 having the same topology as the ESS 420 and executing a multiple-to-one balancing process between battery modules according to an example. The primary controller 402 may execute the process 500 and determine that a difference in SOC between the second battery module 410b and the first battery module 410a exceeds the threshold difference at act 506, and a difference in SOC between the second battery module 410b and the third battery module 410c exceeds the threshold difference at act 506. The second battery module 410b may have the least remaining charge (indicated by the smallest SOC value) of all of the battery modules 410a-410n, and the battery modules 410a, 410c may have the most remaining charge (indicated by the largest SOC value[s]) of all of the battery modules 410a-410n. The battery modules 410a, 410c may thus be considered discharging battery modules, and the second battery module 410b may thus be considered a charging battery module. In executing act 508, the primary controller 402 may identify one or more potential power paths from the discharging battery modules 410a, 410c to the charging battery module 410b. For example, the primary controller 402 may determine that the most efficient charging scheme includes a first power path 2020 from the first battery module 410a to the second battery module 410b and a second power path 2030 from the third battery module 410c to the second battery module 410b.

For example, the Nth battery module 410n is not directly coupled to the first power converter 408a-1 via the power connections 436, 438. In executing act 510, the primary controller 402 controls the power converters 408a-2, 408b-1 to draw power from the first battery module 410a, convert the drawn power (for example, converting DC power to AC power and then to converted DC power), and provide the converted power to the second battery module 410b to charge the second battery module 410b. To convert the drawn power, the primary controller 402 may send control signals to operate the power converters 408a-2, 408b-1 to buck or boost the output voltages of the power converters 408a-2, 408b-1 to desired voltages. The desired voltages may be greater than the voltage of the second battery module 410b so that power can flow from the first battery module 410a to the second battery module 410b through the power converters 408a-2, 408b-1 via the first power path 2020. Meanwhile, in executing act 510, the primary controller 402 controls the power converters 408b-2, 408c-1 to draw power from the third battery module 410c, convert the drawn power (for example, converting DC power to AC power and then to converted DC power), and provide the converted DC power to the second battery modules 410b to charge the second battery modules 410b via the second power path 2030. In this example, the primary controller 402 may only control the power converters 408a-2, 408b-1, 408b-2, 408c-1 to convert power (denoted as “working”), while the remaining power converters may not be converting power.

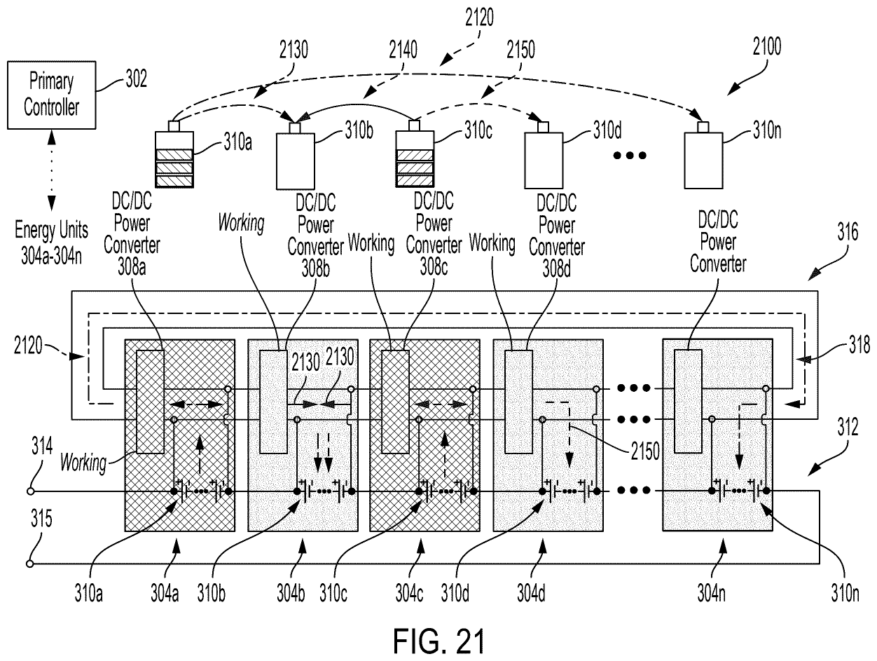

FIG. 21 illustrates a schematic diagram of an ESS 2100 having the same topology as the ESS 300 and executing a multiple-to-multiple balancing process between battery modules according to an example. The primary controller 302 may execute the process 500 and determine that the respective differences in SOC for four pairs of battery modules all exceed the threshold difference at act 506. The first pair includes the battery modules 310a, 310n; the second pair includes the battery modules 310a, 310b; the third pair includes the battery modules 310b, 310c; and the fourth pair includes battery modules 310c, 310d. The battery modules 310b, 310d, 310n may have the least remaining charge (indicated by the smallest SOC value[s]) of all of the battery modules 310a-310n, and the battery modules 310a, 310c may have the most remaining charge (indicated by the largest SOC value[s]) of all of the battery modules 310a-310n. The battery modules 310a, 310c may thus be considered discharging battery modules, and the battery modules 310b, 310d, 310n may thus be considered charging battery modules. In executing act 508, the primary controller 302 may identify one or more potential power paths for each pair of battery modules from the respective discharge battery module to the respective charging battery module. The primary controller 302 may determine that the most efficient charging scheme includes a first power path 2120 from the first battery module 310a to the Nth battery module 310n, a second power path 2130 from the first battery module 310a to the second battery module 310b, a third power path 2140 from the third battery module 310c to the second battery module 310b, and a fourth power path 2150 from the third battery module 310c to the fourth battery module 310d.

For example, the Nth battery module 310n is directly coupled to the first DC/DC power converter 308a via the power connections 316, 318. In executing act 510, the primary controller 302 controls the first DC/DC power converter 308a to draw power from the first battery module 310a, convert the drawn power (for example, converting DC power to converted DC power), and provide the converted power to the Nth battery module 310n to charge the Nth battery module 310n. To convert the drawn power, the primary controller 302 may send control signals to operate the first DC/DC power converter 308a to buck or boost the output voltage of the first DC/DC power converter 308a to a desired voltage. The desired voltage may be greater than the voltage of the Nth battery module 310n so that power can flow from the first battery module 310a to the Nth battery module 310n through the first DC/DC power converter 308a via the first power path 2120. Meanwhile, in executing act 510, the primary controller 302 controls the second DC/DC power converter 308b to draw power from the first battery module 310a, convert the drawn power (for example, converting DC power to converted DC power), and provide the converted power to the second battery module 310b to charge the second battery module 310b via the second power path 2130. Meanwhile, in executing act 510, the primary controller 302 controls the third DC/DC power converter 308c to draw power from the third battery module 310c, convert the drawn power (for example, converting DC power to converted DC power), and provide the converted power to the second battery module 310b to charge the second battery module 310b via the third power path 2140. Meanwhile, in executing act 510, the primary controller 302 controls the fourth DC/DC power converter 308d to draw power from the third battery module 310c, convert the drawn power (for example, converting DC power to converted DC power), and provide the converted power to the fourth battery module 310d to charge the fourth battery module 310d via the fourth power path 2150. In this example, the primary controller 302 may only control the DC/DC power converters 308a, 308b, 308c, 308d to convert power (denoted as “working”), while the remaining power converters may not be converting power.

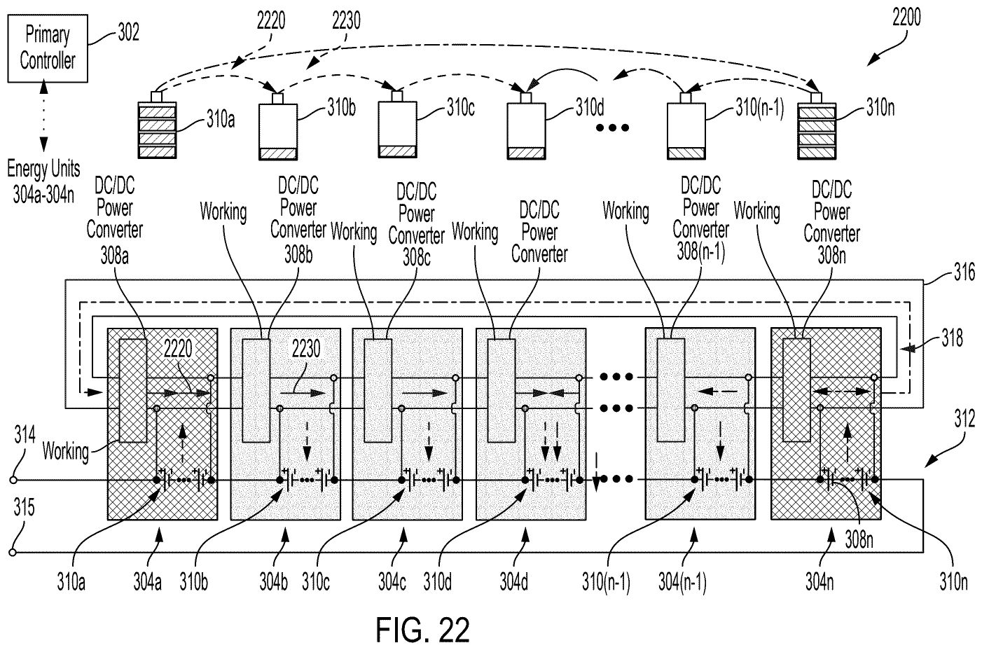

FIG. 22 illustrates a schematic diagram of an ESS 2200 having the same topology as the ESS 300 and executing a multiple-to-multiple balancing process between battery modules according to another example. The primary controller 302 may execute the process 500 and determine that the respective differences in SOC for a large number of pairs of battery modules exceed the threshold difference at act 506. The battery modules 310b, 310(n-1) may have the least remaining charge (indicated by the smallest SOC value[s]) of all of the battery modules 310a-310n, and the battery modules 310a, 310n may have the most remaining charge (indicated by the largest SOC value[s]) of all of the battery modules 310a-310n. The battery modules 310a, 310n may thus be considered discharging battery modules, and the battery modules 310b-310(n-1) may thus be considered charging battery modules. Therefore, each of the discharging battery modules 310a, 310n and each of the charging battery modules 310b-310(n-1) form a pair that satisfies the threshold difference requirement. In executing act 508, the primary controller 302 may identify one or more potential power paths for a respective discharging battery module to a respective charging battery module. The primary controller 302 may determine that the most efficient charging scheme includes a first power path 2220 from the first battery module 310a to the second battery module 310b, a second power path 2230 from the first battery module 310a to the third battery module 310c through the intermediate energy unit 304b, and so on.

For example, the Nth battery module 310n is directly coupled to the first DC/DC power converter 308a via the power connections 316, 318. In executing act 510, the primary controller 302 controls the second DC/DC power converter 308b to draw power from the first battery module 310a, convert the drawn power (for example, converting DC power to converted DC power), and provide the converted power to the second battery module 310b to charge the second battery module 310b. To convert the drawn power, the primary controller 302 may send control signals to operate the second DC/DC power converter 308b to buck or boost the output voltage of the second DC/DC power converter 308b to a desired voltage. The desired voltage may be greater than the voltage of the second battery module 310b so that power can flow from the first battery module 310a to the second battery module 310b through the second DC/DC power converter 308b via the first power path 2220. In addition, in executing act 510, the primary controller 302 controls the DC/DC power converters 308b, 308c to draw power from the first battery module 310a, convert the drawn power (for example, converting DC power to converted DC power), and provide the converted power to the third battery module 310c to charge the third battery module 310c via the second power path 2230. The second power path 2230 may include the first power path 2220. In this manner, each battery module electrically located between battery modules 310a, 310n can draw power from the first battery module 310a, the Nth battery module 310n, or both, according to the corresponding most efficient power path that passes through the lowest number of DC/DC power converters. In this example, the primary controller 302 may control all the DC/DC power converters 308a-308n to convert power (denoted as “working”).

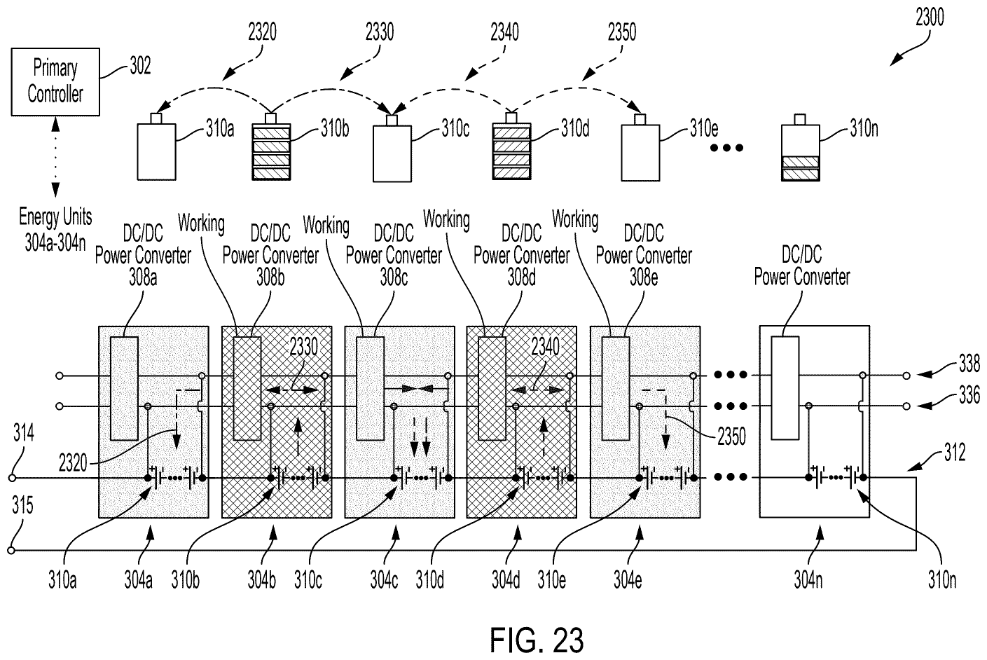

FIG. 23 illustrates a schematic diagram of an ESS 2300 having the same topology as the ESS 320 and executing a multiple-to-multiple balancing process between battery modules according to an example. The primary controller 302 may execute the process 500 and determine that the respective differences in SOC for four pairs of battery modules exceed the threshold difference at act 506. The first pair includes the battery modules 310a, 310b; the second pair includes the battery modules 310b, 310c; the third pair includes the battery modules 310c, 310d; and the fourth pair includes battery modules 310d, 310e. The battery modules 310a, 310c, 310e may have the least remaining charge (indicated by the smallest SOC value[s]) of all of the battery modules 310a-310n, and the battery modules 310b, 310d may have the most remaining charge (indicated by the largest SOC value[s]) of all of the battery modules 310a-310n. The battery modules 310b, 310d may thus be considered discharging battery modules, and the battery modules 310a, 310c, 310e may thus be considered charging battery modules. In executing act 508, the primary controller 302 may identify one or more potential power paths for each pair of battery modules from the discharging battery modules to the charging battery modules. The primary controller 302 may determine that the most efficient charging scheme includes a first power path 2320 from the second battery module 310b to the first battery module 310a, a second power path 2330 from the second battery module 310b to the third battery module 310c, a third power path 2340 from the fourth battery module 310d to the third battery module 310c, and a fourth power path 2350 from the fourth battery module 310d to the fifth battery module 310e.

For example, the Nth battery module 310n is not directly coupled to the first DC/DC power converter 308a via the power connections 336, 338. In executing act 510, the primary controller 302 controls the second DC/DC power converter 308b to draw power from the second battery module 310b, convert the drawn power (for example, converting DC power to converted DC power), and provide the converted power to the first battery module 310a to charge the first battery module 310a. To convert the drawn power, the primary controller 302 may send control signals to operate the second DC/DC power converter 308b to buck or boost the output voltage of the second DC/DC power converter 308b to a desired voltage. The desired voltage may be greater than the voltage of the first battery module 310a so that power can flow from the second battery module 310b to the first battery module 310a through the second DC/DC power converter 308b via the first power path 2320.

Meanwhile, in executing act 510, the primary controller 302 controls the third DC/DC power converter 308c to draw power from the second battery module 310b, convert the drawn power (for example, converting DC power to converted DC power), and provide the converted power to the third battery module 310c to charge the third battery module 310c via the second power path 2330. Meanwhile, in executing act 510, the primary controller 302 controls the fourth DC/DC power converter 308d to draw power from the fourth battery module 310d, convert the drawn power (for example, converting DC power to converted DC power), and provide the converted power to the third battery module 310c to charge the third battery module 310c via the third power path 2340. Meanwhile, in executing act 510, the primary controller 302 controls the fifth DC/DC power converter 308e to draw power from the fourth battery module 310d, convert the drawn power (for example, converting DC power to converted DC power), and provide the converted power to the fifth battery module 310e to charge the fifth battery module 310e via the fourth power path 2350.

In this example, the primary controller 302 may only control the DC/DC power converters 308b, 308c, 308d, 308e to convert power (denoted as “working”), while the remaining power converters may not be converting power.

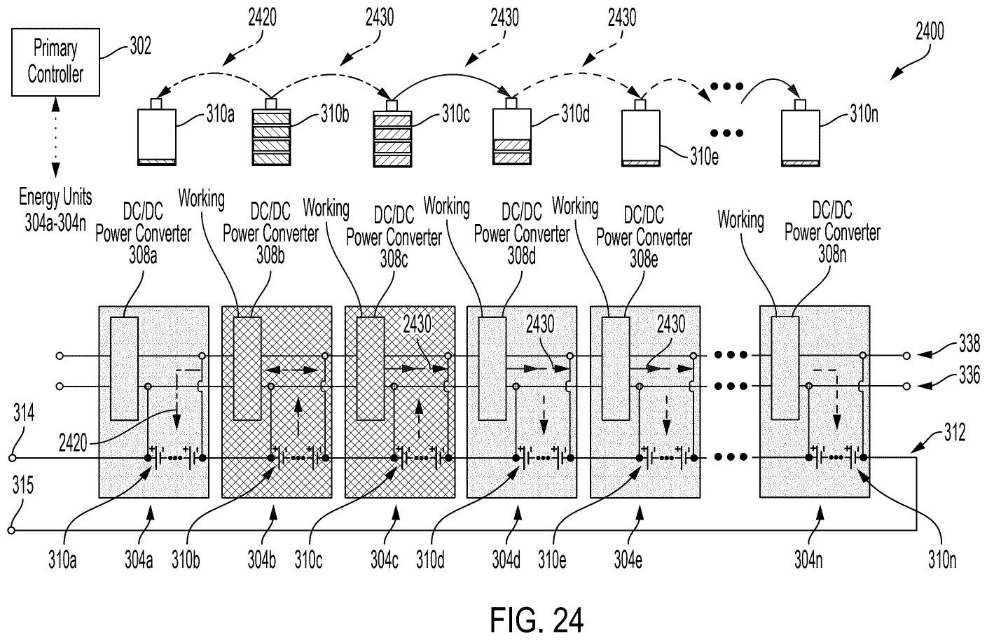

FIG. 24 illustrates a schematic diagram of an ESS 2400 having the same topology as the ESS 320 and executing a multiple-to-multiple balancing process between battery modules according to another example. The primary controller 302 may execute the process 500 and determine that the respective differences in SOC for a large number of pairs of battery modules exceed the threshold difference at act 506. The battery modules 310a, 310e-310n may have the least remaining charge (indicated by the smallest SOC value[s]) of all of the battery modules 310a-310n, and the battery modules 310b, 310c may have the most remaining charge (indicated by the largest SOC value[s]) of all of the battery modules 310a-310n. The battery modules 310b, 310c may thus be considered discharging battery modules, and the battery modules 310a, 310e-310n may thus be considered charging battery modules. Therefore, each of the discharging battery modules 310b, 310c and each of the charging battery modules 310a, 310e-310n form a pair that satisfies the threshold difference requirement. In executing act 508, the primary controller 302 may identify one or more potential power paths from a respective discharging battery module to a respective charging battery module for each pair of battery modules. The primary controller 302 may determine that the most efficient charging scheme includes a first power path 2420 from the second battery module 310b to the first battery module 310a, a second power path 2430 from the second battery module 310b to the fifth battery module 310e through the intermediate energy units 304c, 304d, and so on.

For example, the Nth battery module 310n is not directly coupled to the first DC/DC power converter 308b via the power connections 336, 338. In executing act 510, the primary controller 302 controls the second DC/DC power converter 308b to draw power from the second battery module 310b, convert the drawn power (for example, converting DC power to converted DC power), and provide the converted power to the first battery module 310a to charge the first battery module 310a. To convert the drawn power, the primary controller 302 may send control signals to operate the second DC/DC power converter 308b to buck or boost the output voltage of the second DC/DC power converter 308b to a desired voltage. The desired voltage may be greater than the voltage of the first battery module 310a so that power can flow from the second battery module 310b to the first battery module 310a through the second DC/DC power converter 308b via the first power path 2420.

Meanwhile, in executing act 510, the primary controller 302 controls the DC/DC power converters 308c, 308d, 308e to draw power from the battery modules 310b, 310c, convert the drawn power (for example, converting DC power to converted DC power), and provide the converted power to the fifth battery module 310e to charge the fifth battery module 310e via the second power path 2430. In this manner, each battery module located on the “right-hand” side of the discharging battery modules 310b, 310c can draw power from the discharging battery modules 310b, 310c according to the corresponding most efficient power path that passes through the lowest number of DC/DC power converters. In this example, the primary controller 302 may control the DC/DC power converters 308b-308n to convert power (denoted as “working”), whereas the first DC/DC power converter 308a may not convert power.

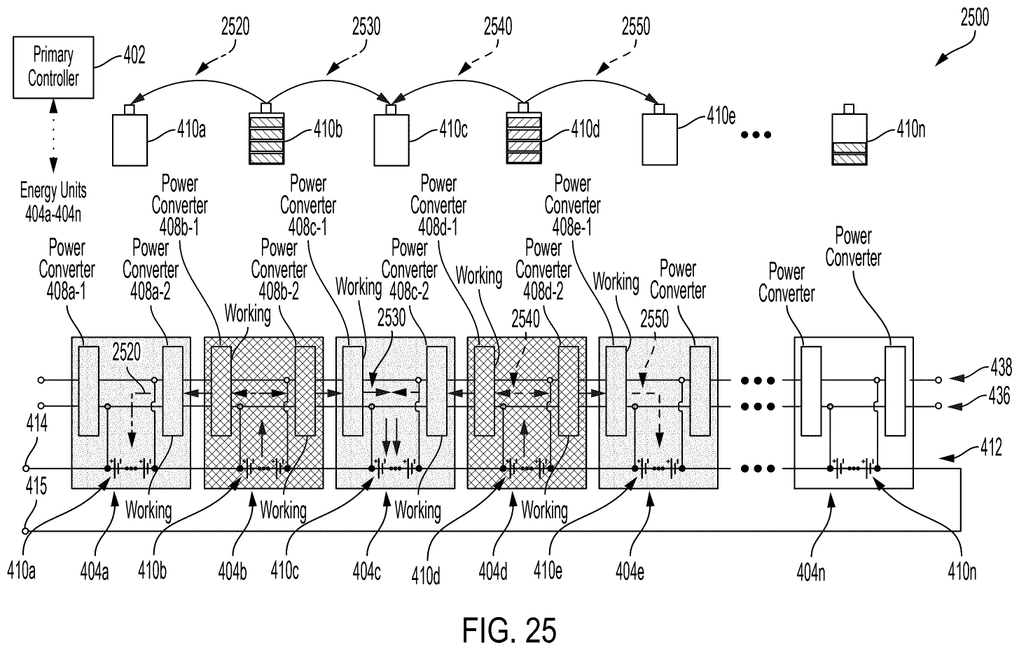

FIG. 25 illustrates a schematic diagram of an ESS 2500 having the same topology as the ESS 420 and executing a multiple-to-multiple balancing process between battery modules according to an example. The primary controller 402 may execute the process 500 and determine that the respective differences in SOC for four pairs of battery modules exceed the threshold difference at act 506. The first pair includes the battery modules 410a, 410b; the second pair includes the battery modules 410b, 410c; the third pair includes the battery modules 410c, 410d; and the fourth pair includes battery modules 410d, 410e. The battery modules 410a, 410c, 410e may have the least remaining charge (indicated by the smallest SOC value[s]) of all of the battery modules 410a-410n, and the battery modules 410b, 410d may have the most remaining charge (indicated by the largest SOC value[s]) of all of the battery modules 410a-410n. The battery modules 410b, 410d may thus be considered discharging battery modules, and the battery modules 410a, 410c, 410e may thus be considered charging battery modules. In executing act 508, the primary controller 302 may identify one or more potential power paths for each pair of battery modules from the respective discharging battery module to the respective charging battery module. The primary controller 402 may determine that the most efficient charging scheme includes a first power path 2520 from the second battery module 410b to the first battery module 410a, a second power path 2530 from the second battery module 410b to the third battery module 410c, a third power path 2540 from the fourth battery module 410d to the third battery module 410c, and a fourth power path 2550 from the fourth battery module 410d to the fifth battery module 410e.

For example, the Nth battery module 410n is not directly coupled to the first power converter 408a-1 via the power connections 436, 438. In executing act 510, the primary controller 402 controls the power converters 408a-2, 408b-1 to draw power from the second battery module 410b, convert the drawn power (for example, converting DC power to AC power then to converted DC power), and provide the converted power to the first battery module 410a to charge the first battery module 410a. To convert the drawn power, the primary controller 402 may send control signals to operate the power converters 408a-2, 408b-1 to buck or boost the output voltage of the power converters 408a-2, 408b-1 to desired voltages. The desired voltages may be greater than the voltage of the first battery module 410a so that power can flow from the second battery module 410b to the first battery module 410a through the power converters 408a-2, 408b-1 via the first power path 2520.

Meanwhile, in executing act 510, the primary controller 402 controls the power converters 408b-2, 408c-1 to draw power from the second battery module 410b, convert the drawn power (for example, converting DC power to AC power then to converted DC power), and provide the converted power to the third battery module 410c to charge the third battery module 410c via the second power path 2530. Meanwhile, in executing act 510, the primary controller 402 controls the power converters 408c-2, 408d-1 to draw power from the fourth battery module 410d, convert the drawn power (for example, converting DC power to AC power then to converted DC power), and provide the converted power to the third battery module 410c to charge the third battery module 410c via the third power path 2540. Meanwhile, in executing act 510, the primary controller 402 controls the power converters 408d-2, 408e-1 to draw power from the fourth battery module 410d, convert the drawn power (for example, converting DC power to AC power then to converted DC power), and provide the converted power to the fifth battery module 410e to charge the fifth battery module 410e via the fourth power path 2550.

In this example, the primary controller 402 may only control the power converters 408a-2, 408b-1, 408b-2, 408c-1, 408c-2, 408d-1, 408d-2, 408e-1 to convert power (denoted as “working”), while the remaining power converters may not be converting power.

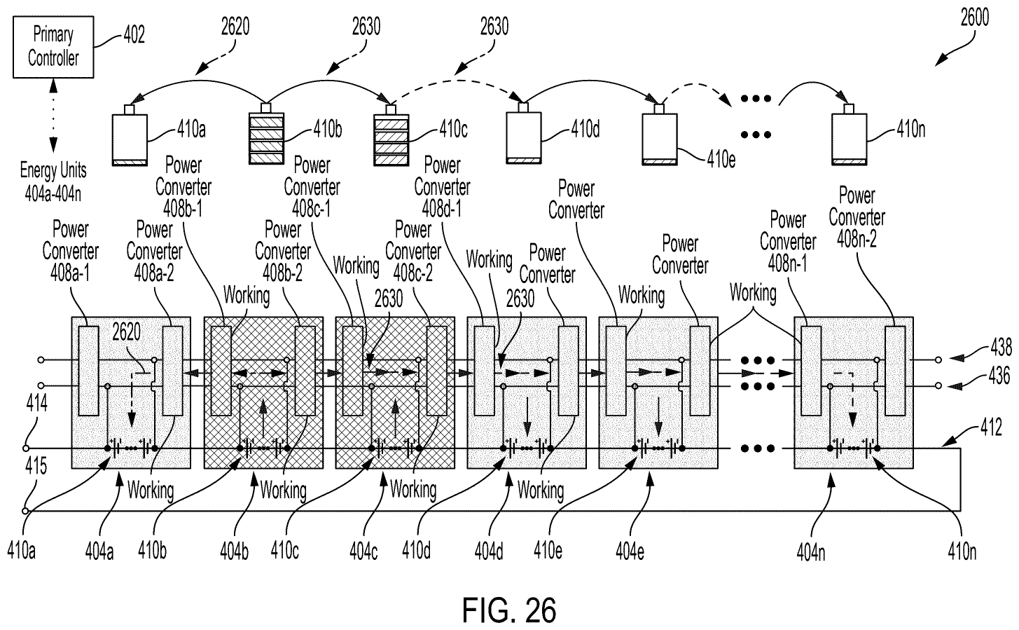

FIG. 26 illustrates a schematic diagram of an ESS 2600 having the same topology as the ESS 420 and executing a multiple-to-multiple balancing process between battery modules according to another example. The primary controller 402 may execute the process 500 and determine that the respective differences in SOC for a large number of pairs of battery modules exceed the threshold difference at act 506. The battery modules 410a, 410d-410n may have the least remaining charge (indicated by the smallest SOC value[s]) of all of the battery modules 410a-410n, and the battery modules 410b, 410c may have the most remaining charge (indicated by the largest SOC value[s]) of all of the battery modules 410a-410n. The battery modules 410b, 410c may thus be considered discharging battery modules, and the battery modules 410a, 410d-410n may thus be considered charging battery modules. Therefore, each of the discharging battery modules 410b, 410c and each of the charging battery modules 410a, 410d-410n form a pair that satisfies the threshold difference requirement. In executing act 508, the primary controller 402 may identify one or more potential power paths from a respective discharging battery module to a respective charging battery module for each pair of battery modules. The primary controller 402 may determine that the most efficient charging scheme includes a first power path 2620 from the second battery module 410b to the first battery module 410a, a second power path 2630 from the second battery module 410b to the fourth battery module 410d through the intermediate energy unit 404c, and so on.

For example, the Nth battery module 410n is not directly coupled to the first power converter 408a-1 via the power connections 436, 438. In executing act 510, the primary controller 402 controls the power converters 408a-2, 408b-1 to draw power from the second battery module 410b, convert the drawn power (for example, converting DC power to AC power then to converted DC power), and provide the converted power to the first battery module 410a to charge the first battery module 410a. To convert the drawn power, the primary controller 402 may send control signals to operate the power converters 408a-2, 408b-1 to buck or boost the output voltage of the power converters 408a-2, 408b-1 to desired voltages. The desired voltages may be greater than the voltage of the first battery module 410a so that power can flow from the second battery module 410b to the first battery module 410a through the power converters 408a-2, 408b-1 via the first power path 2620.

Meanwhile, in executing act 510, the primary controller 402 controls the power converters 408b-2, 408c-1, 408c-2, 408d-1 to draw power from at least one of the battery modules 410b, 410c, convert the drawn power (for example, converting DC power to AC power then to converted DC power), and provide the converted power to the fourth battery module 410d to charge the fourth battery module 410d via the second power path 2630. In this manner, each battery module located on the “right-hand” side of the discharging battery modules 410b, 410c can draw power from the discharging battery modules 410b, 410c according to the corresponding most efficient power path that passes through the lowest number of power converters. In this example, the primary controller 402 may control the power converters 408b-408n convert power (denoted as “working”), whereas the power converters 408a-1, 408n-2 may not convert power.

Additional examples are within the scope of the disclosure. For example, the controller 112 of the UPS 100 may be, or may replace, the primary controller 202. The controller 112 of the UPS 100 may also include, or may replace, the secondary controllers 206. In some examples, the threshold difference implemented at act 506 may be zero such that any difference in SOC with the battery modules in the ESS 130 can be balanced immediately.

Various controllers, such as the primary controller 202 and secondary controllers 206, may execute various operations discussed above. The primary controller 202 and/or secondary controllers 206 may also execute one or more instructions stored on one or more non-transitory computer-readable media, which the primary controller 202 and/or secondary controllers 206 may include and/or be coupled to, which may result in manipulated data. The non-transitory computer-readable media may include memory and/or storage. In some examples, the primary controller 202 and/or secondary controllers 206 may include one or more processors or other types of controllers. In one example, the primary controller 202 and/or secondary controllers 206 may include at least one processor. In another example, the primary controller 202 and/or secondary controllers 206 perform at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Among other advantages, example ESSs, methods, at least one non-transitory computer-readable medium described herein may allow fast and efficient balancing of battery modules in an ESS without disrupting the normal operation of the ESS. Example ESSs disclosed herein may be more cost-effective compared to other ESSs at least in part by minimizing the number of power converters used to implement battery-module balancing. In some examples, this may allow lower-rated power converters to be used and may avoid using busbars for better insulation among the energy units.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. An energy-storage system, comprising:
a plurality of energy units, each energy unit including a battery module and a power converter coupled to a respective battery module; and
at least one controller configured to:
receive one or more parameter values from each battery module, each parameter value indicating a respective battery module state,
determine a difference between a largest parameter value from a first battery module and a smallest parameter value from a second battery module,
determine whether the difference is greater than a threshold difference, and
control at least one power converter to transfer energy between the first battery module and the second battery module through a lowest number of power converters in response to determining that the difference is greater than the threshold difference.

2. The energy-storage system of claim 1, wherein the at least one controller is further configured to:
determine one or more power paths between the first battery module and the second battery module, each power path including one or more power converters;
determine a number of power converters in each power path;
identify a most efficient power path between the first battery module and the second battery module, wherein the most efficient power path includes the lowest number of power converters; and
control at least one power converter to transfer energy between the first battery module and the second battery module through the most efficient power path.

3. The energy-storage system of claim 1, wherein the battery module state includes at least one of a state of charge or a state of health of a respective battery module.

4. The energy-storage system of claim 1, wherein the power converters of the plurality of energy units are coupled in series.

5. The energy-storage system of claim 1, wherein each energy unit includes a battery module, a first power converter, and a second power converter, each first power converter and each second power converter being coupled to a respective battery module and to each other.

6. The energy-storage system of claim 5, wherein each first power converter and each second power converter are both DC/DC converters or are both AC/DC converters.

7. The energy-storage system of claim 5, wherein the plurality of energy units includes:
a first energy unit having the first battery module; and
a second energy unit having the second battery module,
wherein transferring energy between the first battery module and the second battery module includes transferring energy through a second respective power converter of the first energy unit and a first respective power converter of the second energy unit.

8. The energy-storage system of claim 1, wherein the at least one controller is further configured to:
determine a second difference between a parameter value from a third battery module and the smallest parameter value from the second battery module,
determine whether the second difference is greater than the threshold difference, and
control at least one power converter to transfer energy between the third battery module and the second battery module through a second lowest number of power converters in response to determining that the second difference is greater than the threshold difference.

9. The energy-storage system of claim 1, wherein the at least one controller is further configured to:
determine a second difference between the largest parameter value from the first battery module and a parameter value from a third battery module,
determine whether the second difference is greater than the threshold difference, and
control at least one power converter to transfer energy between the first battery module and the third battery module through a second lowest number of power converters in response to determining that the second difference is greater than the threshold difference.

10. The energy-storage system of claim 1, wherein:
each energy unit further includes a secondary controller, each secondary controller being communicatively coupled to the at least one controller, the respective power converter, and the respective battery module;
receiving the one or more parameter values from each battery module includes receiving the one or more parameter values from a respective secondary controller; and
controlling the at least one power converter includes providing control signals to at least one respective secondary controller.

11. A method of controlling an energy-storage system comprising a plurality of energy units, each energy unit including a respective battery module and a respective power converter coupled to the respective battery module, the method comprising:
receiving one or more parameter values from each battery module, each parameter value indicating a respective battery module state;
determining a difference between a largest parameter value from a first battery module and a smallest parameter value from a second battery module;
determining that the difference is greater than a threshold difference; and
controlling at least one power converter to transfer energy between the first battery module and the second battery module through a lowest number of power converters in response to determining that the difference is greater than the threshold difference.

12. The method of claim 11, wherein controlling the at least one power converter to transfer energy between the first battery module and the second battery module through the lowest number of power converters includes:
determining one or more power paths between the first battery module and the second battery module, each power path including one or more power converters;
determining a number of power converters in each power path;
identifying a most efficient power path between the first battery module and the second battery module, wherein the most efficient power path including the lowest number of power converters; and
controlling at least one power converter to transfer energy between the first battery module and the second battery module through the most efficient power path.

13. The method of claim 11, further comprising:
determining a second difference between a parameter value from a third battery module and the smallest parameter value from the second battery module;
determining that the second difference is greater than the threshold difference; and
controlling at least one power converter to transfer energy between the third battery module and the second battery module through a second lowest number of power converters in response to determining that the second difference is greater than the threshold difference.

14. The method of claim 11, further comprising:
determining a second difference between the largest parameter value from the first battery module and a parameter value from a third battery module,
determining that the second difference is greater than the threshold difference, and
controlling at least one power converter to transfer energy between the first battery module and the third battery module through a second lowest number of power converters in response to determining that the second difference is greater than the threshold difference.

15. The method of claim 11, wherein:
each energy unit includes a respective battery module, a first respective power converter, and a second respective power converter, the first respective power converter and the second respective power converter being coupled to the respective battery module and to each other; and
transferring energy between the first respective battery module and the second respective battery module includes transferring energy through a second respective power converter coupled to the first battery module and a first respective power converter coupled to the second battery module.

16. At least one non-transitory computer-readable medium storing thereon sequences of computer-executable instructions for controlling an energy-storage system comprising a plurality of energy units, each energy unit including a respective battery module and a respective power converter coupled to the respective battery module, the sequences of computer-executable instructions including instructions that instruct at least one processor to:
receive one or more parameter values from each battery module, each parameter value indicating a respective battery module state;
determine a difference between a largest parameter value from a first battery module of a first energy unit and a smallest parameter value from a second battery module of a second energy unit;
determine whether the difference is greater than a threshold difference; and
control at least one power converter to transfer energy between the first battery module and the second battery module through a lowest number of power converters in response to determining that the difference is greater than the threshold difference.

17. The at least one non-transitory computer-readable medium of claim 16, wherein controlling the at least one power converter to transfer energy between the first battery module and the second battery module through the lowest number of power converters includes:
identifying a most efficient power path between the first battery module and the second battery module, the most efficient power path including the lowest number of power converters; and
controlling the at least one power converter to transfer energy between the first battery module and the second battery module through the most efficient power path.

18. The at least one non-transitory computer-readable medium of claim 16, wherein:
each energy unit includes a respective battery module, a first respective power converter, and a second respective power converter, the first respective power converter and the second respective power converter being coupled to the respective battery module and to each other; and
transferring energy between the first battery module of the first energy unit and the second battery module of the second energy unit includes transferring energy through the second respective power converter of the first energy unit and the first respective power converter of the second energy unit.

19. The at least one non-transitory computer-readable medium of claim 16, wherein the instructions further instruct the at least one processor to:
determine a second difference between a parameter value from a third battery module and the smallest parameter value from the second battery module;
determine whether the second difference is greater than the threshold difference; and
control at least one power converter to transfer energy between the third battery module and the second battery module through a second lowest number of power converters in response to determining that the second difference is greater than the threshold difference.

20. The at least one non-transitory computer-readable medium of claim 16, wherein the instructions further instruct the at least one processor to:
determine a second difference between the largest parameter value from the first battery module and a parameter value from a third battery module;
determine whether the second difference is greater than the threshold difference; and
control at least one power converter to transfer energy between the first battery module and the third battery module through a second lowest number of power converters in response to determining that the second difference is greater than the threshold difference.
